(19) United States
(12) Patent Application Publication
(10) Pub. No.: US 2024/0166798 A1
(43) Pub. Date: May 23, 2024

(54) EPOXY RESIN COMPOSITION, PREPREG, AND FIBER-REINFORCED COMPOSITE MATERIAL

(71) Applicant: Toray Industries, Inc., Tokyo (JP)

(72) Inventors: Hiroshi Kobayashi, Tacoma, WA (US); Benjamin Rutz, Tacoma, WA (US); Koji Furukawa, Tacoma, WA (US); Toshiya P. Kamae, Tacoma, WA (US)

(73) Assignee: Toray Industries, Inc., Tokyo (JP)

(21) Appl. No.: 18/280,510

(22) PCT Filed: Mar. 24, 2022
(86) PCT No.: PCT/IB2022/000151

§ 371 Date: Sep. 6, 2023

Related U.S. Application Data
(60) Provisional application No. 63/168,738, filed on Mar. 31, 2021.
(60) Provisional application No. 63/168,717, filed on Mar. 31, 2021.
(60) Provisional application No. 63/318,249, filed on Mar. 9, 2022.

(51) Int. Cl. C08G 59/32; C08G 59/40; C08G 59/50; C08G 59/68; C08J 5/24

(52) U.S. Cl. CPC C08G 59/3227; C08G 59/4035; C08G 59/5033; C08G 59/686; C08G 59/688; C08J 5/246; C08J 2363/00

(57) ABSTRACT

A first epoxy resin composition is described that includes [A] at least one epoxy resin, [B] at least two hardeners comprising [B-1] at least a first hardener and [B-2] at least a second hardener different from the first hardener, and [C] at least one accelerator, wherein the epoxy resin composition satisfies 5.0>|T₁−T₂|, where [A], [B], [C], T₁ and T₂ are as defined. A second epoxy resin composition is described that includes [A] at least one epoxy resin, [B] at least two hardeners comprising [B-1] at least one amine compound and [B-2] at least one organic acid hydrazide compound, and [C] at least one accelerator comprising [C-1] at least one organophosphorus compound, where [A], [B] and [C-1] are as defined. A prepreg comprising reinforcing fiber bundles impregnated with the first epoxy resin or the second epoxy resin is also described as well as a fiber-reinforced composite material.

### CROSS-REFERENCE TO RELATED APPLICATIONS

This application is the U.S. National Phase of PCT/IB2022/000151, filed Mar. 24, 2022, which claims priority to U.S. Provisional Application No. 63/318,249, filed Mar. 9, 2022; U.S. Provisional Application No. 63/168,738, filed Mar. 31, 2021; and U.S. Provisional Application No. 63/168,717, filed Mar. 31, 2021, the disclosures of these applications being incorporated herein by reference in their entireties for all purposes.

### FIELD OF THE INVENTION

The present invention relates to an epoxy resin composition which combines excellent latency with excellent curability that renders the composition curable in a short time, where the epoxy resin composition may be used in a fiber-reinforced composite material, to a prepreg formed by impregnating the epoxy resin composition into reinforcing fibers, and to a fiber-reinforced composite material including the epoxy resin composition and the reinforcing fibers.

### BACKGROUND OF THE INVENTION

Composite materials containing reinforcing fibers, such as carbon fibers or glass fibers, and a thermosetting resin, such as an epoxy resin or a phenolic resin, have found application in fields such as aerospace, automobiles, rail cars, marine vessels, civil engineering and construction, and sporting goods since the composite materials are lightweight yet exhibit excellent mechanical properties such as strength and rigidity, heat resistance and corrosion resistance. For applications which require high performance, a composite material containing continuous reinforcing fibers is a frequent choice. As the reinforcing fibers, carbon fibers exhibit excellent specific strength and specific modulus. As a matrix resin, a thermosetting resin, particularly an epoxy resin which adheres well to carbon fibers, is often selected due to its heat resistance, elastic modulus, chemical resistance, and low cure shrinkage.

As a hardener of the epoxy resin, aliphatic amine compounds, aromatic amine compounds, acid anhydrides, and imidazole derivatives are often used in combination. Particularly for aerospace applications which require heat resistance under high humidity conditions, aromatic amine compounds are desirable because they exhibit excellent latency in a resin composition and heat resistance in a cured object.

However, since aromatic amine compounds are generally less reactive with epoxy resins compared to other hardeners, prolonged heating at high curing temperatures near 180° C. is typically required during molding of an epoxy resin composition. If the reactivity of an epoxy resin composition with a hardener is low, high energy costs associated with long molding times undesirably result.

In contrast, the ability of a composite structure to cure at low temperatures provides a variety of benefits. In one aspect, tooling such as molds which are employed to shape the composites may be made from lower cost, low temperature materials, rather than more expensive materials capable of withstanding higher curing temperatures. Further, curing at relatively low temperatures may desirably inhibit void formation. Relatively low temperature curing may also be preferred for vacuum bag-only composite processing because of the aforementioned advantages. Therefore, a technology which enables curing of an epoxy resin composition at low temperatures in a short time would be highly valuable. However, development of epoxy resin compositions as matrix resins for use in composites, adhesives, and surfacing films, where the epoxy resin compositions are capable of curing at relatively low temperatures but still retain a good pot life and mechanical properties, is ongoing.

Use of an accelerator (a catalyst) for accelerating curing of an epoxy resin composition is known. Dicyandiamide, urea, imidazole, boron trifluoride (BF₃), amine complexes, and boron trichloride (BCl₃) have been employed as low temperature hardeners and/or accelerators. While some of these hardener systems exhibit relatively good stability at room temperature (e.g., a tack life greater than about one week), due to either latency or low reactivity, they are all associated with drawbacks. For example, some of these hardener systems undesirably lower the mechanical properties of the resultant composite, while other hardeners undesirably increase the brittleness of the matrix resin, which in turn lowers the toughness of the composite. In another examples, the modulus of the matrix resin is lowered and/or the propensity of the matrix resin to absorb moisture is increased, each of which reduces the hot and wet mechanical performance of the resultant composite. In addition, some of these hardener systems exhibit reactivities which are too high, thereby undesirably reducing the pot life of the matrix resin.

US 2010/0222461 A1 describes an epoxy resin composition that includes an epoxy resin and a dual curing system of one or more curing agents containing one or more organic acid hydrazide compounds as hydrazine-based curing agents and one or more curing agents containing one or more amine functional groups. The hydrazide-amine curing system enables the epoxy composition to achieve elevated levels of gelation or degree of cure at lower temperatures compared to amine-based curing agents alone.

Similarly, US 2017/0362427 A1 describes an epoxy resin composition that includes an epoxy resin, an aromatic amine compound, an organic acid hydrazide compound and a thermoplastic resin. The composition achieves a latency with good curability wherein the viscosity of the epoxy resin composition after being held at 80° C. for 2 hours, is up to 2.0 times higher than the initial viscosity at 80° C.

WO 2019/219953 A1 describes a curative resin composition that includes an epoxy phenolic resin, a carboxylic hydrazide hardener, and a hydroxy substituted urone but fails to disclose a combination of said hydrazide, said urone, and a second hardener different from the hydrazide. The composition achieves a latency with good curability wherein the viscosity of the epoxy resin composition after being held at 80° C. for 2 hours, is up to 2.0 times higher than the initial viscosity at 80° C.

### SUMMARY OF THE INVENTION

To solve the aforementioned problems, the inventors have discovered that specific combinations of at least one first hardener, at least one second hardener different from the first hardener and at least one accelerator, wherein the accelerator accelerates the reaction between the second hardener and an epoxy resin(s) but not substantially between the first hardener and the epoxy resin(s), achieves excellent latency with excellent curability that renders the composition curable in a short time, which makes the composition desirable for producing a fiber-reinforced composite material, a prepreg formed by impregnating the epoxy resin composition into reinforcing fibers, and a composite material containing the epoxy resin composition and reinforcing fibers.

An aspect of the invention relates to an epoxy resin composition comprising:
[A] at least one epoxy resin,
[B] at least two hardeners comprising:
   [B-1] at least a first hardener,
   [B-2] at least a second hardener different from the first hardener, and
[C] at least one accelerator,
wherein the epoxy resin composition satisfies (I):

5.0>|T₁−T₂| (I),
where
T₁ is the extrapolated onset temperature (° C.) for reaction of a mixture of [A] and [B-1],
T₂ is the extrapolated onset temperature (° C.) for reaction of a mixture of [A], [B-1], and [C],
wherein the extrapolated onset temperatures T₁, and T₂ are determined by differential scanning calorimetry (DSC) with a heating rate of 10° C./min using the aforementioned mixtures having an equivalent ratio of all active hydrogens of [B-1] or [B-2] to all epoxy groups of [A] of 1.0 and a mass ratio of [C] to [A] of 1:100.

In an embodiment, the epoxy resin composition further satisfies (II):

5.0≤T₃−T₄ (II)
where
   T₃ is an extrapolated onset temperature (° C.) for reaction of a mixture of [A] and [B-2]; and
   T₄ is an extrapolated onset temperature (° C.) for reaction of a mixture of [A], [B-2], and [C],
   wherein the extrapolated onset temperatures T₃ and T₄ are determined by differential scanning calorimetry with a heating rate of 10° C./min of the T₃ and T₄ mixtures having an equivalent ratio of all active hydrogens of [B-2] to all epoxy groups of [A] in the mixtures of 1.0 and a mass ratio of [C] to [A] of 1:100.

In an embodiment, the component [B-2] comprises at least one organic acid hydrazide compound.

In an embodiment, the component [C] comprises at least one compound selected from the group consisting of organophosphine compounds, phosphonium salts, and ammonium salts.

In an embodiment, the component [C] is at least one compound selected from the group consisting of triphenylphosphine, tetraphenylphosphonium bromide, triphenylphosphine triphenylborane, and tetrabutylammonium trifluoromethanesulfonate.

In an embodiment, the component [C] is present in an amount of 0.1 to 10 parts by mass relative to 100 parts by mass of the component [A].

In an embodiment, the component [A] is present in an amount of 100 parts by mass, the component [B-2] is present in an amount of 1 to 20 parts by mass, and the component [C] is present in an amount of 0.1 to 10 parts by mass, and wherein an equivalent ratio of all active hydrogens of the [B-1] and [B-2] components to all epoxy groups of the component [A] is 0.7 to 1.3.

Another aspect relates to an epoxy resin composition comprising:
[A] at least one epoxy resin;
[B] at least two hardeners comprising:
   [B-1] at least a first hardener;
   [B-2] at least a second hardener different from the first hardener; and
[C] at least one accelerator,
   wherein [B-1] comprises at least one amine compound, and
   wherein [B-2] comprises at least one organic acid hydrazide compound, and
   wherein [C] comprises:
[C-1] at least one organophosphorus compound;
   wherein the component [C-1] accelerates reaction of the component [A] and at least one hardener, and
   wherein the component [A] is present in an amount of 100 parts by mass, the component [B-2] is present in an amount of 1 to 20 parts by mass, and the component [C-1] is present in an amount of 0.1 to 10 parts by mass, and
   wherein an equivalent ratio of all active hydrogens of the [B-1] and [B-2] components to all epoxy groups of the component [A] is 0.7 to 1.3.

In an embodiment, a ratio (V₂/V₁) of viscosity of the epoxy resin composition measured after being held at 80° C. for 4 hours (V₂) to that measured after being held at 80° C. for 1 minute (V₁) is 2.5 or less, such as 2.0 or less.

In an embodiment, the component [A] comprises at least one epoxy resin having three or more epoxy groups.

In an embodiment, the component [A] comprises at least one compound selected from the group consisting of a tetraglycidyl diaminodiphenyl methane, a meta- or para-aminophenol epoxy resin, and a bisnaphthalene epoxy resin.

In an embodiment, the component [B-1] comprises at least one amine compound.

In an embodiment, the component [B-1] comprises at least one aromatic amine compound.

In an embodiment, the component [B-1] comprises 3,3′-diaminodiphenylsulfone and/or 4,4′-diaminodiphenylsulfone.

In an embodiment, the component [B-2] has at least one aromatic ring structure.

In an embodiment, the component [B-2] comprises at least one compound selected from the group consisting of 3-hydroxy-2-naphthoic acid hydrazide, 2,6-naphthalenedicarbodihydrazide, and isophthalic dihydrazide.

In an embodiment, an equivalent ratio of all active hydrogens of the component [B-1] to all active hydrogens of the component [B-2] is from 1 to 10.

In an embodiment, component [C-1] has a melting point of 220° C. or less, when measured by differential scanning calorimetry with a heating rate of 10° C./min.

In an embodiment, the epoxy resin composition satisfies (V) and (VI):

5.0>|T₁−T₅| (V); and

2.0>|Tₚ₁−T₅ₚ| (VI);
where
   T₁ is an extrapolated onset temperature (° C.) for reaction of a mixture of [A] and [B-1];
   T₅ is an extrapolated onset temperature (° C.) for reaction of a mixture of [A], [B-1], and [C-1];
   T₁ₚ is a peak temperature (° C.) for reaction of a mixture of [A] and [B-1]; and
   T₅ₚ is a peak temperature (° C.) for reaction of a mixture of [A], [B-1], and [C-1];
wherein the extrapolated onset temperatures T₁ and T₅ and the peak temperatures T₁ₚ and T₅ₚ are determined by differential scanning calorimetry with a heating rate of 10° C./min using the aforementioned mixtures having an equivalent ratio of all active hydrogens of [B-1] or [B-2] to all epoxy groups of [A] in the mixtures of 1.0 and a mass ratio of [C-1] to [A] of 1:100.

In an embodiment, the component [C-1] comprises at least one organophosphine compound.

In an embodiment, the component [C-1] is at least one compound selected from the group consisting of triphenylphosphine, tri-o-tolylphosphine, tri-m-tolylphosphine, tri-p-tolylphosphine, tris(p-methoxyphenyl)phosphine, diphenylcyclohexylphosphine, triphenylphosphine oxide, and triphenylphosphine triphenylborane.

In an embodiment, the epoxy resin composition further comprises at least one thermoplastic resin.

In an embodiment, the thermoplastic resin is present in an amount of 1 to 30 parts by mass relative to 100 parts by mass of the component [A].

Another aspect relates to a prepreg comprising reinforcing fiber bundles impregnated with an epoxy resin composition as disclosed herein.

In an embodiment, a fiber-reinforced composite material is obtained by curing a prepreg as disclosed herein.

In another embodiment, a fiber-reinforced composite material comprises a cured epoxy resin product obtained by curing a mixture comprising an epoxy resin composition as disclosed herein, and a reinforcing fiber.

### DETAILED DESCRIPTION OF EMBODIMENTS OF THE INVENTION

All publications, patents, and patent applications cited in this specification are hereby incorporated by reference in their entireties for all purposes.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” are used to describe and account for small fluctuations. For example, they can refer to amounts or quantities that differ from a stated value by less than or equal to ±5%.

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification is not necessarily referring to the same embodiment. Furthermore, the particular features, structures, or characteristics may be combined in any suitable manner in one or more embodiments.

Unless otherwise specified, “room temperature” as used herein refers to a temperature of 23° C.

As used herein, the term, “fiber-reinforced composite material” may be used interchangeably with the terms “fiber-reinforced composite”, “fiber-reinforced polymer material”, “fiber-reinforced plastic material” and “fiber-reinforced plastic”.

The present invention relates to an epoxy resin composition which combines excellent latency with excellent curability that renders the composition curable in a short time, making it useful for producing a fiber-reinforced composite material, to a prepreg formed by impregnating the epoxy resin composition into reinforcing fibers, and to a composite material including the epoxy resin composition and reinforcing fibers.

In accordance with the present disclosure, a prepreg having excellent latency with excellent curability that provides a fiber-reinforced composite material in a short time can be obtained. Moreover, by using the prepreg of the present disclosure, a carbon fiber-reinforced composite material without any significant drawbacks in mechanical properties can be obtained by curing this prepreg.

The epoxy resin composition, the prepreg, and the carbon fiber-reinforced composite material of the present disclosure are described in detail below.

The inventors have discovered that the aforementioned deficiencies associated with the conventional art are resolved by employing, in fiber-reinforced composite material applications, an epoxy resin composition comprising:
[A] at least one epoxy resin,
[B] at least two hardeners comprising:
   [B-1] at least a first hardener,
   [B-2] at least a second hardener different from the first hardener, and
[C] at least one accelerator,
wherein the epoxy resin composition satisfies (I) and (II):

5.0>|T₁−T₂| (I)

5.0≤T₃−T₄ (II)
where
T₁ is the extrapolated onset temperature (° C.) for reaction of a mixture of [A] and [B-1];
T₂ is the extrapolated onset temperature (° C.) for reaction of a mixture of [A], [B-1], and [C];
T₃ is the extrapolated onset temperature (° C.) for reaction of a mixture of [A] and [B-2]; and
T₄ is the extrapolated onset temperature (° C.) for reaction of a mixture of [A], [B-2]; and [C],
   wherein the extrapolated onset temperatures T₁, T₂, T₃ and T₄ are determined by differential scanning calorimetry with a heating rate of 10° C./min using the aforementioned mixtures having an equivalent ratio of all active hydrogens of [B-1] or [B-2] to all epoxy groups of [A] of 1.0 and a mass ratio of [C] to [A] of 1:100.

Hereinafter, various non-limiting embodiments of exemplary epoxy resin compositions, prepregs, and fiber-reinforced composite materials obtained by curing the prepreg of the present invention will be described in more detail. An aspect of the present invention is an epoxy resin composition including at least one epoxy resin [A], at least two different hardeners [B], and at least one accelerator [C], where the epoxy resin composition is characterized by satisfying the aforementioned relationships (I) and (II). First, the epoxy resin [A] will be described.

### [A] Epoxy Resin

There are no specific limitations or restrictions regarding the component [A] used in the present invention, as long as it is an epoxy resin having one or more glycidyl groups in the molecule.

In embodiments, the component [A] has two or more glycidyl groups, such as three or more glycidyl groups, such as four or more glycidyl groups, such as five or more glycidyl groups, such as six or more glycidyl groups, such as seven or more glycidyl groups, in a molecule. In embodiments, the component [A] has 2 to 10 glycidyl groups, such as 2 to 8 glycidyl groups, such as 2 to 5 glycidyl groups, such as 2, 3, 4, 5, 6, 7, 8, 9 or 10 glycidyl groups. In the case of the epoxy resin having less than two glycidyl groups in a molecule, there is a possibility that the glass transition temperature of a cured epoxy resin composition obtained by curing an epoxy resin composition is lowered.

Non-limiting examples of the component [A] include bisphenol type epoxy resins (such as a bisphenol A type epoxy resin, a bisphenol F type epoxy resin, a bisphenol AD type epoxy resin, and a bisphenol S type epoxy resin); brominated epoxy resins (such as tetrabromobisphenol A diglycidyl ether); novolac type epoxy resins (such as epoxy resins having a biphenyl backbone, epoxy resins having a naphthalene backbone, epoxy resins having a dicyclopentadiene backbone, phenol novolac type epoxy resins, and cresol novolac type epoxy resins); glycidyl amine type epoxy resins (such as N,N,O-triglycidyl-m-aminophenol, N,N,O-triglycidyl-p-aminophenol, N,N,O-triglycidyl-4-amino-3-methyl phenol, N,N,N′,N′-tetraglycidyl-4,4′-methylene dianiline, N,N,N′,N′-tetraglycidyl-2,2′-diethyl-4,4′-methylene dianiline, N,N,N′,N′-tetraglycidyl-m-xylylene diamine, N,N-diglycidyl aniline, and N,N-diglycidyl-o-toluidine); and others such as resorcin diglycidyl ether and triglycidyl isocyanurate. In particular, epoxy resins having three or more glycidyl groups in a molecule can form cured epoxy resin compositions having high glass transition temperatures and an elastic modulus and accordingly are suitable for use in the aviation and aerospace industries.

These epoxy resins may be used singly or as an appropriate mixture so that the cured epoxy resin composition and a fiber-reinforced composite material exhibit the intended mechanical properties and heat resistance. Combining an epoxy resin showing fluidity at an appropriate temperature with an epoxy resin showing no fluidity at an appropriate temperature is effective for fluidity control of the matrix resin during heat-curing of the resulting prepreg. For example, if the fluidity of the matrix resin is too high before the start of gelation in the curing step by heating, distortion in the alignment of reinforcing fibers may take place or the matrix resin may flow out of the system, causing the fiber mass content to fall outside of the predetermined range, possibly resulting in a carbon fiber-reinforced composite material with deteriorated mechanical properties. Combining a plurality of epoxy resins showing different viscoelastic behaviors is effective for providing a prepreg having appropriate levels of tackiness and drapability.

The epoxy resin composition according to the present invention may contain resins containing only one epoxy group in a molecule (monoepoxy resins) and alicyclic epoxy resins, unless they result in a significant reduction in heat resistance or mechanical properties.

In certain embodiments of the present invention, the component [A] includes a bisnaphthalene type epoxy resin with at least di-functionality as represented by the general formula (A-1) shown below and an epoxy resin with at least tri-functionality other than said bisnaphthalene type epoxy resin. The adoption of such an approach in selecting the epoxy resin serves to provide an epoxy resin composition that can form a cured epoxy resin composition exhibiting high heat resistance under water absorbing conditions.

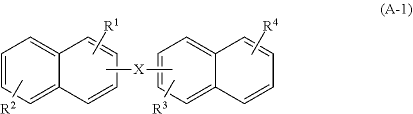

In the general formula (A-1), X represents an alkylene group having 1 to 8 carbon atoms (such as 1 to 6 carbon atoms, such as 1 to 4 carbon atoms) or a group represented by the following general formula (A-2); R¹ to R⁵ each independently represents a group represented by the following general formula (A-3) or (A-4), a hydrogen atom, a halogen atom (such as one or more of F, Cl, Br and I), a phenyl group or an alkyl group having 1 to 4 carbon atoms (such as 1 to 3 carbon atoms, such as 1 to 2 carbon atoms); R¹ to R⁴ may be bonded to either ring of the two naphthalene rings, or to both rings; R⁵ may be attached at any open position on the benzene ring; three or more of R¹ to R⁵ are represented by the following general formula (A-3), or alternatively, at least one group represented by the general formula (A-3) and at least one group represented by the general formula (A-4) need to be included among R¹ to R⁵, with the other R¹ to R⁵ substituents being the same as or different from each other. Regarding (A-3) and (A-4), the oxiranylmethyl group and the oxirane ring portion of the glycidyl group will also be referred to herein as a glycidyl group or functionality and an epoxy group or functionality, respectively.

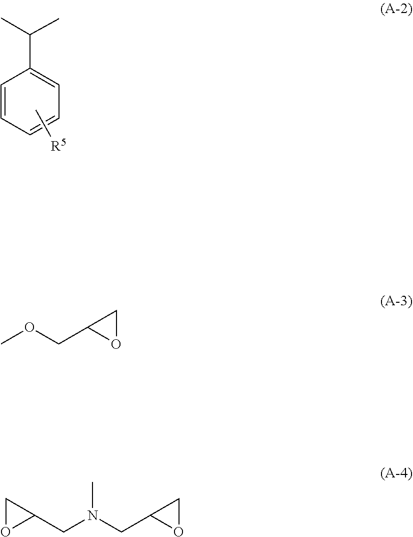

Any production method may be used to prepare an epoxy resin as represented general formula (A-1). In an exemplary embodiment, (A-1) may be prepared through a reaction between a hydroxynaphthalene and epihalohydrin.

In an embodiment, the bisnaphthalene epoxy resin preferably contains 2 to 10, more preferably 2 to 5, glycidyl groups. If too many glycidyl groups are present, there is a possibility that the resulting cured epoxy resin composition will be sufficiently brittle that the impact resistance will deteriorate in some cases.

In certain embodiments, the content of the bisnaphthalene type epoxy resin is preferably 10 to 50 parts by mass, more preferably 20 to 40 parts by mass, and particularly preferably 25 to 30 parts by mass, relative to 100 parts by mass of epoxy resins in an epoxy resin composition. Having a content of 10 parts by mass or more enables the production of a cured epoxy resin composition and a resulting fiber-reinforced composite material exhibiting high heat resistance. On the other hand, having a content of 50 parts by mass or less enables the production of a cured epoxy resin composition and a resulting fiber-reinforced composite material exhibiting high elongation.

Specific examples of the bisnaphthalene include, but are not limited to, EPICLON® HP-4700, EPICLON® HP-4710, EPICLON® HP-4770, EPICLON® EXA-4701, and EPICLON® EXA-4750 (all manufactured by DIC Corporation).

In an embodiment, the epoxy resin having at least tri-functionality is an epoxy resin other than the bisnaphthalene type epoxy resin containing three or more epoxy groups in a molecule. Examples of an epoxy resin with at least tri-functionality include glycidyl amine type epoxy resins, glycidyl ether type epoxy resins, and aminophenol type epoxy resins.

In another embodiment, the above epoxy resin having at least tri-functionality preferably contains 3 to 7, more preferably 3 to 4, epoxy groups. If too many glycidyl groups are present, there is a possibility that the resulting cured epoxy resin composition may be sufficiently brittle that the impact resistance will deteriorate in some cases.

Examples of glycidyl amine type epoxy resins having at least tri-functionality include diaminodiphenyl methane type epoxy resins, diaminodiphenyl sulfone type epoxy resins, metaxylenediamine type epoxy resins, 1,3-bisaminomethyl cyclohexane type epoxy resins, and isocyanurate type epoxy resins.

Examples of glycidyl ether type epoxy resins having at least tri-functionality include phenol novolac type epoxy resins, orthocresol novolac type epoxy resins, tris-hydroxyphenyl methane type epoxy resins, and tetraphenylol ethane type epoxy resins.

Furthermore, in addition to the above glycidyl amine type epoxy resins having at least tri-functionality and glycidyl ether type epoxy resins having at least tri-functionality, other suitable epoxy resins having at least tri-functionality include aminophenol type epoxy resins, which contain both a glycidyl amine group and a glycidyl ether group in the molecule.

Of the epoxy resins having at least tri-functionality described above, diaminodiphenyl methane type epoxy resins and aminophenol type epoxy resins are particularly preferred because of a good balance among desired physical properties.

The heat resistance of the fiber-reinforced composite material can decrease if the content of the above epoxy resin having at least tri-functionality is too small whereas the cross-linking density can increase, leading to a brittle material if the content is too large, possibly resulting in a cured epoxy resin composition and a resulting fiber-reinforced composite material suffering from deterioration in both impact resistance and strength. Accordingly, the content of the epoxy resins having at least tri-functionality is preferably 20 to 80 parts by mass, more preferably 30 to 70 parts by mass, and particularly preferably 40 to 60 parts by mass, relative to 100 parts by mass of epoxy resins in an epoxy resin composition.

Specific examples of the epoxy resins having at least tri-functionality include, but are not limited to, SUMI-EPDXY® ELM434, SUMI-EPDXY® ELM434VL (both manufactured by Sumitomo Chemical Co., Ltd.), ARALDITE® MY720, ARALDITE® MY721, ARALDITE® MY9512, ARALDITE® MY9655, and ARALDITE® MY9663 (all manufactured by Huntsman Corporation), Epotohto® YH-434 (manufactured by Nippon Steel & Sumikin Chemical Co., Ltd.), SUMI-EPDXY® ELM120 and SUMI-EPDXY® ELM100 (both manufactured by Sumitomo Chemical Co., Ltd.), jER™ 630 (Mitsubishi Chemical Corporation), ARALDITE® MY0500, ARALDITE® MY0510, and ARALDITE® MY0600 (all manufactured by Huntsman Corporation).

Specific examples of the meta-xylene diamine type epoxy resin include TETRAD-X (manufactured by Mitsubishi Gas Chemical Co., Inc.).

Specific examples of the 1,3-bisaminomethyl cyclohexane type epoxy resin include TETRAD-C (manufactured by Mitsubishi Gas Chemical Co., Inc.).

Specific examples of the isocyanurate epoxy resin include TEPIC®-P (Nissan Chemical Industries, Ltd.).

Specific examples of the phenol novolac type epoxy resin include D.E.N.™ 431 and D.E.N.™ 438 (both manufactured by The Dow Chemical Company) and jER™ 152 (manufactured by Mitsubishi Chemical Corporation).

Specific examples of the orthocresol novolac type epoxy resin include EOCN-1020 (manufactured by Nippon Kayaku Ltd.) and EPICLON® N-660 (manufactured by DIC Corporation).

Specific examples of the tris-hydroxyphenyl methane type epoxy resin include Tactix® 742 (manufactured by Huntsman Corporation).

Specific examples of the tetraphenylol ethane type epoxy resin include jER™ 1031S (manufactured by Mitsubishi Chemical Corporation).

Specific examples of the dicyclopentadiene type epoxy resin include EPICLON® HP-7200 (manufactured by DIC Corporation).

Specific examples of the resorcinol type epoxy resin include DENACOL™ EX-201 (manufactured by Nagase ChemteX Corporation).

Specific examples of the urethane modified epoxy resin include AER4152 (manufactured by Asahi Kasei E-materials Corp.).

Specific examples of the phenol aralkyl type epoxy resin include NC-3000 (manufactured by Nippon Kayaku Co., Ltd.).

In certain embodiments of the present invention, the component [A] includes an epoxy resin having one or more ring structures containing 4 or more ring atoms (such as C, N, O and/or S) and at least one glycidyl amine group or glycidyl ether group directly connected to the ring structure(s), the epoxy resin having at least tri-functionality. The adoption of such an approach serves to provide an epoxy resin composition that can form a fiber-reinforced composite material with high tensile strength at low temperatures. Herein, the term “having one or more ring structures containing 4 or more members” means either containing one or more monocyclic ring structures each having four or more ring atoms, such as cyclohexane, benzene, and pyridine, or containing at least one condensed ring structure having four or more ring atoms, such as phthalimide, naphthalene, and carbazole.

A glycidyl amine group or glycidyl ether group directly connected to a ring structure in the epoxy resin as described above has a structure in which the nitrogen (N) atom of the glycidyl amine group or the oxygen (0) atom of the glycidyl ether group is connected to the ring structure of the benzene, phthalimide, etc., and the epoxy resin has mono-functionality or di-functionality in the case where it contains a glycidyl amine group or has mono-functionality in the case where it contains a glycidyl ether group.

In an embodiment, the aforementioned epoxy resin may be an epoxy resin having di-functionality that has a structure as represented by the general formula (A-5) shown below.

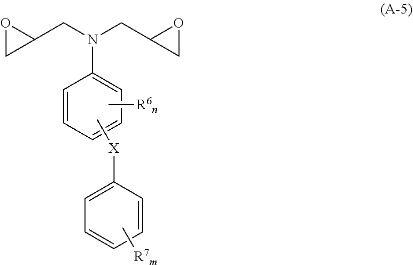

In the general formula (A-5), R⁶ and R⁷ are each at least one independently selected from the group consisting of a hydrogen atom (H), an aliphatic hydrocarbon group with a carbon number of 1 to 4 (such as 1 to 2), an alicyclic hydrocarbon group with a carbon number of 3 to 6 (such as 5 to 6), an aromatic hydrocarbon group with a carbon number of 6 to 10 (such as 6), a halogen atom (such as F, Cl, Br or I), an acyl group, a trifluoromethyl group, and a nitro group. Here, n is an integer of 0 to 4 and m is an integer of 0 to 5. When n or m is an integer of 2 or more, the R⁶ and R⁷ substituents may be either identical to or different from each other. X represents one selected from the group consisting of —O—, —S—, —CO—, —C(═O)O—, and —SO₂—.

When the content of an epoxy resin having one or more ring structures containing 4 or more ring atoms and at least one glycidyl amine group or glycidyl ether group directly connected to the ring structure is proper, both the tensile strength and the heat resistance of the resulting fiber-reinforced composite material may be positively impacted. Accordingly, the content of said epoxy resin is preferably 5 to 60 parts by mass relative to 100 parts by mass of all epoxy resins present in an epoxy resin composition.

In an embodiment, the use of an epoxy resin having mono-functionality leads to a fiber-reinforced composite material exhibiting higher tensile strength while the use of an epoxy resin having di-functionality leads to a fiber-reinforced composite material exhibiting higher heat resistance.

In the case of using an epoxy resin with mono-functionality, the content of said epoxy resin is preferably 10 to 30 parts by mass, more preferably 15 to 25 parts by mass, relative to 100 parts by mass of all epoxy resins present in an epoxy resin composition. In the case of using an epoxy resin with di-functionality, the content of said epoxy resin is preferably 10 to 40 parts by mass, more preferably 20 to 30 parts by mass, relative to 100 parts by mass of all epoxy resins present in an epoxy resin composition.

Examples of an epoxy resin with mono-functionality include, but are not limited to, glycidylphthalimide, glycidyl-1,8-naphthalimide, glycidylcarbazole, glycidyl-3,6-dibromocarbazole, glycidylindole, glycidyl-4-acetoxyindole, glycidyl-3-methylindole, glycidyl-3-acetylindole, glycidyl-5-methoxy-2-methylindole, o-phenylpheny Iglycidyl ether, p-phenylphenyl glycidyl ether, p-(3-methylphenyl)phenyl glycidyl ether, 2,6-dibenzylphenyl glycidyl ether, 2-benzylphenyl glycidyl ether, 2,6-diphenylphenyl glycidyl ether, 4-a-cumylphenyl glycidyl ether, o-phenoxyphenyl glycidyl ether, and p-phenoxyphenyl glycidyl ether.

Examples of an epoxy resin with di-functionality include, but are not limited to, N,N-diglycidyl-4-phenoxy aniline, N,N-diglycidyl-4-(4-methylphenoxy) aniline, N,N-diglycidyl-4-(4-tert-butylphenoxy) aniline, and N,N-diglycidyl-4-(4-phenoxyphenoxy) aniline. In many cases, these epoxy resins can be produced by adding epichlorohydrin to a phenoxy aniline derivative and cyclizing with an alkali compound. Since the viscosity increases with increasing molecular weight, N,N-diglycidyl-4-phenoxy aniline, which is represented by the general formula (A-5) in which both R⁶ and R⁷ are hydrogen atoms, is particularly preferred from the viewpoint of handleability.

Examples of phenoxy aniline derivatives include, but are not limited to, 4-phenoxy aniline, 4-(4-methylphenoxy) aniline, 4-(3-methylphenoxy) aniline, 4-(2-methylphenoxy) aniline,4-(4-ethylphenoxy) aniline, 4-(3-ethylphenoxy) aniline, 4-(2-ethylphenoxy) aniline,4-(4-propylphenoxy) aniline, 4-(4-tert-butylphenoxy) aniline, 4-(4-cyclohexylphenoxy) aniline,4-(3-cyclohexylphenoxy) aniline, 4-(2-cyclohexylphenoxy) aniline, 4-(4-methoxyphenoxy)aniline, 4-(3-methoxyphenoxy) aniline, 4-(2-methoxyphenoxy) aniline, 4-(3-phenoxyphenoxy) aniline, 4-(4-phenoxyphenoxy) aniline, 4-[4-(trifluoromethyl) phenoxy] aniline, 4-[3-(trifluoromethyl) phenoxy] aniline, 4-[2-(trifluoromethyl) phenoxy] aniline, 4-(2-naphthyloxyphenoxy) aniline, 4-(1-naphthyloxyphenoxy) aniline, 4-[(1,1′-biphenyl-4-yl)oxy] aniline, 4-(4-nitrophenoxy) aniline, 4-(3-nitrophenoxy) aniline, 4-(2-nitrophenoxy) aniline, 3-nitro-4-aminophenyl phenyl ether, 2-nitro-4-(4-nitrophenoxy) aniline, 4-(2,4-dinitrophenoxy) aniline, 3-nitro-4-phenoxy aniline, 4-(2-chlorophenoxy) aniline, 4-(3-chlorophenoxy) aniline, 4-(4-chlorophenoxy) aniline, 4-(2,4-dichlorophenoxy) aniline, 3-chloro-4-(4-chlorophenoxy) aniline, and 4-(4-chloro-3-tolyloxy) aniline.

Specific examples of an epoxy resin with mono-functionality include, but are not limited to, DENACOL™ EX-731 (glycidylphthalimide, manufactured by Nagase ChemteX Corporation) and OPP-G (o-phenylphenylglycidyl ether, manufactured by Sanko Co., Ltd.), and specific examples of epoxy resin with di-functionality include GAN (N-diglycidyl aniline, manufactured by Nippon Kayaku Co., Ltd.) and TOREP® A-204E (diglycidyl-p-phenoxy aniline, manufactured by Toray Fine Chemicals Co., Ltd.).

In certain embodiments of the present invention, the component [A] includes a meta- or para-aminophenol type epoxy resin and either a glycidyl ether type epoxy resin or a glycidyl amine type epoxy resin having two or more glycidyl groups in a molecule other than said meta- or para-aminophenol type epoxy resin. Inclusion of such epoxy resins serves to provide an epoxy resin composition that can form a cured epoxy resin composition exhibiting high heat resistance.

In an embodiment, the content of the meta- or para-aminophenol type epoxy resin is preferably 10 to 50 parts by mass, more preferably 15 to 40 parts by mass, and still more preferably 20 to 30 parts by mass, relative to 100 parts by mass of all epoxy resins present in an epoxy resin composition, with the objective of producing a cured epoxy resin composition that exhibits superior toughness, elongation percentage, and heat resistance.

In an embodiment, the meta- or para-aminophenol type epoxy resin may be at least one selected from the group consisting of epoxy resins having structures as represented by the general formula (A-6) shown below, and derivatives thereof.

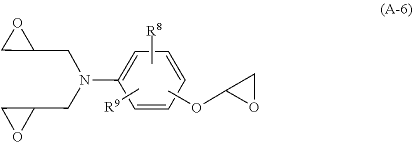

In the general formula (A-6), R⁸ and R⁹ represent at least one selected from the group consisting of a hydrogen atom, an aliphatic hydrocarbon group with a carbon number of 1 to 4, an alicyclic hydrocarbon group with a carbon number of 4 or less (such as 3, 2 or 1), and a halogen atom (such as F, Cl, Br or I).

If the structures of R⁸ and R⁹ in the general formula (A-6) are too sterically large, the viscosity of the epoxy resin composition may be so high as to result in a decrease in handleability, and the compatibility between the meta- or para-aminophenol epoxy resin and other components of the epoxy resin composition may decrease, resulting in deterioration of the desired mechanical properties associated with a fiber-reinforced composite material containing the epoxy resin composition.

Specific examples of the meta- or para-aminophenol type epoxy resin include, but are not limited to, triglycidyl-m-aminophenol, triglycidyl-p-aminophenol, and derivatives and isomers thereof.

In particular, R⁸ and R⁹ are each preferably a hydrogen atom from the viewpoint of compatibility with other epoxy resins, and more preferably triglycidyl-m-aminophenol or triglycidyl-p-aminophenol with the objective of improving the elastic modulus and heat resistance of the resulting fiber-reinforced composite material. Triglycidyl-meta-aminophenol can provide high elastic modulus and triglycidyl-p-aminophenol can provide high heat resistance. From the viewpoint of fire retardant properties, it is also preferable for R⁸ and/or R⁹ to be substituted by halogen atoms such as Cl and Br.

Specific examples of the meta- or para-aminophenol type epoxy resin include, but are not limited to, SUMI-EPDXY® ELM120 and SUMI-EPDXY® ELM100 (both manufactured by Sumitomo Chemical Co., Ltd.), jER™ 630 (manufactured by Mitsubishi

Chemical Corporation), and ARALDITE® MY0500, ARALDITE® MY0510, ARALDITE® MY0600, and ARALDITE® MY0610 (all manufactured by Huntsman Corporation).

Non-limiting examples of the glycidyl ether type epoxy resin and the glycidyl amine type epoxy resin having two or more glycidyl groups in a molecule other than the meta- or para-aminophenol type epoxy resin include bisphenol type epoxy resins (such as a bisphenol A type epoxy resin, a bisphenol F type epoxy resin, a bisphenol AD type epoxy resin, and a bisphenol S type epoxy resin); brominated bisphenol type epoxy resins (such as tetrabromobisphenol A dilycidyl ether); and others such as an alicyclic epoxy resin, diaminodiphenyl methane, diaminodiphenyl sulfone, diaminodiphenyl ether, xylene diamine, constitutional isomers thereof, and compounds produced by glycidylating the amino group in a derivative containing a halogen atom or an alkyl substituent with a carbon number of 3 or less, used as precursor. Such glycidyl amine type epoxy resins include, but are not limited to, tetraglycidyl diaminodiphenyl methane, glycidyl compounds of xylene diamine, tetraglycidyl diaminodiphenyl sulfone, and tetraglycidyl diaminodiphenyl ether.

In an embodiment, liquid bisphenol A type epoxy resins and bisphenol F type epoxy resins, which are low in viscosity, are preferably used in combination with other epoxy resins.

In another embodiment, compared to liquid bisphenol A type epoxy resins, solid bisphenol A type epoxy resins form a structure with a low crosslinking density that is lower in heat resistance but higher in toughness, and accordingly are used in combination with a glycidyl amine type epoxy resin, liquid bisphenol A type epoxy resin, or bisphenol F type epoxy resin.

Specific examples of the bisphenol A type epoxy resin include, but are not limited to, jER™ 825, jER™ 827, jER™ 828, jER™ 834, jER™ 1001, jER™ 1004, jER™ 1004AF, and jER™ 1007 (all manufactured by Mitsubishi Chemical Corporation), EPICLON® 850 (manufactured by DIC Corporation), Epotohto® YD-128 (manufactured by Nippon Steel & Sumikin Chemical Co., Ltd.), and D.E.R.™ 331 and D.E.R.™ 332 (both manufactured by The Dow Chemical Company).

Specific examples of the bisphenol F type epoxy resin include, but are not limited to, jER™ 806, jER™ 807, jER™ 1750, jER™ 4004P, and jER™ 4005P (all manufactured by Mitsubishi Chemical Corporation), EPICLON® 830 (manufactured by DIC Corporation), and Epotohto® YDF-170 (manufactured by Nippon Steel & Sumikin Chemical Co., Ltd.).

Specific examples of the glycidyl amine type epoxy resin include, but are not limited to, SUMI-EPDXY® ELM434, SUMI-EPDXY® ELM434VL (both manufactured by Sumitomo Chemical Co., Ltd.), ARALDITE® MY720, ARALDITE® MY721, ARALDITE® MY9512, ARALDITE® MY9655, and ARALDITE® MY9663 (all manufactured by Huntsman Corporation), and Epotohto® YH-434 (manufactured by Nippon Steel & Sumikin Chemical Co., Ltd.).

If the content of the glycidyl ether type epoxy resin or the glycidyl amine type epoxy resin is low in the case where the meta- or para-aminophenol type epoxy resin and either the glycidyl ether type epoxy resin or the glycidyl amine type epoxy resin having two or more glycidyl groups in a molecule are used in combination, the mechanical properties of a fiber-reinforced composite material containing such an epoxy resin may be negatively impacted, whereas if the content is too high, the heat resistance may be negatively impacted when the bisphenol type epoxy resin is used or the toughness may be negatively impacted when the glycidyl amine type epoxy resin is used.

From the viewpoint of control of heat resistance and resin viscosity as described above and also from the viewpoint of the elongation percentage and toughness of the resin, it is preferable in an embodiment for the glycidyl ether type epoxy resin and/or the glycidyl amine type epoxy resin to be present in an amount of 50 to 90 parts by mass, more preferably 55 to 85 parts by mass, and particularly preferably 60 to 80 parts by mass, relative to 100 parts by mass of all epoxy resins present in an epoxy resin composition.

In an embodiment, the component [A] includes a ladder type silsesquioxane compound containing an epoxy ring as the epoxy resin.

In another embodiment, the structure of the ladder type silsesquioxane compound containing an epoxy ring may be selected from the silsesquioxanes as represented by the general formula (A-7) below and derivatives thereof. Blending of these ladder type silsesquioxanes in an epoxy resin composition serves to increase flame retardant properties and heat resistance.

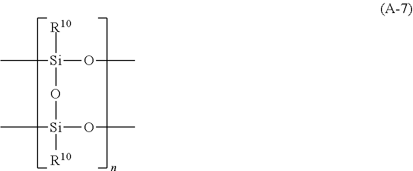

In a ladder type silsesquioxane compound containing an epoxy ring structure, the epoxy ring groups account for 50 to 100 mol %, preferably 60 to 100 mol %, of the substituents R¹⁰ in the general formula (A-7). If the proportion of the epoxy ring groups present as the substituent R¹⁰ in the general formula (A-7) is controlled within this range, the epoxy resin composition exhibits an appropriate viscosity for improved handleability and moldability, possibly leading to a fiber-reinforced composite material exhibiting flame retardant properties, heat resistance, and mechanical properties at a high level. The proportion of the epoxy ring groups (mol %) can be calculated as follows:

(quantity of epoxy groups in ladder type silsesquioxane (mol))/(total quantity of substituents in ladder type silsesquioxane (mol))×100.

The proportion of epoxy ring groups in a ladder type silsesquioxane can also be determined by organic elemental analysis, ICP-MS (inductively coupled plasma mass spectroscopy), etc., of the epoxy resin composition.

In an embodiment, examples of the substituent R¹⁰ in the general formula (A-7) include glycidoxy alkyl groups with a carbon number of 4 or less, preferably 3 or less, such as 3, 2 or 1, such as a β-glycidoxy ethyl group, a γ-glycidoxy propyl group, and a γ-glycidoxy butyl group; and alkyl groups substituted by cycloalkyl groups that have a carbon number of 5 to 8 and contain an oxirane group such as a glycidyl group, a β-(3,4-epoxycyclohexyl)ethyl group, a γ-(3,4-epoxycyclohexyl)propyl group, a β-(3,4-epoxycycloheptypethyl group, a β-(3,4-epoxycyclohexyl)propyl group, a β-(3,4-epoxycyclohexyl)butyl group, and a β-(3,4-epoxycyclohexyl)pentyl group, of which alkyl groups having a carbon number of 3 or less and substituted by cycloalkyl groups that have a carbon number of 5 to 8 and contain an oxirane group are preferred. In particular, a β-glycidoxy ethyl group, a γ-glycidoxy propyl group, and a β-(3,4-epoxy cyclohexyl) ethyl group are preferred.

In another embodiment, examples of the substituent R¹⁰ in the general formula (A-7) containing no epoxy ring groups include a hydrogen atom, alkyl groups with a carbon number of 1 to 10 (such as 1 to 8, such as 1 to 6, such as 1 to 3), and alkoxy groups with a carbon number of 1 to 10 (such as 1 to 8, such as 1 to 6, such as 1 to 3). The alkyl groups with a carbon number of 1 to 10 include, for example, a methyl group, ethyl group, propyl group, butyl group, isopropyl group, and isobutyl group. The alkoxy groups with a carbon number of 1 to 10 include a methoxy group, ethoxy group, propoxy group, and butoxy group.

It is preferable for the ladder type silsesquioxanes used in the present invention to have a weight-average molecular weight of 1,500 to 30,000, more preferably 1,500 to 15,000, and particularly preferably 2,000 to 8,000. Ladder type silsesquioxanes having a weight-average molecular weight in this range, permits, for example, achieving a sufficient heat resistance and elongation percentage, improving the compatibility between the ladder type silsesquioxane and other epoxy resins, and improving the impregnation of reinforcing fibers with matrix resins. The weight-average molecular weight referred to herein is the polystyrene-based molecular weight measured by GPC (gel permeation chromatography).

Specific examples of the ladder type silsesquioxanes containing an epoxy ring group include SE-01GM (manufactured by Nagase ChemteX Corporation).

If the ladder type silsesquioxane compound is added to the epoxy resin composition used for the present invention, the result is a fiber-reinforced composite material having flame retardant properties, heat resistance, and mechanical properties at a high level, where the ladder type silsesquioxane is present in an amount of 1 to 40 parts by mass, preferably 5 to 30 parts by mass, and more preferably 10 to 20 parts by mass, relative to the total quantity of the ladder type silsesquioxane compound and all other epoxy resins, which accounts for 100 parts by mass, in the epoxy resin composition.

### [B] Hardener

The choice of hardeners used as the component [B] in the present invention is not limited to any particular hardener, as long as the relationships between T₁, T2, T₃ and T₄ as defined in (I) and (II) described herein are satisfied, and may depend on the application requirements. Generally, a first hardener [B-1] and a second hardener [B-2] different from the first hardener [B-1] may be selected from, for example, but not limited to, amine compounds, amido amines, anhydrides, carbodiimides, dicyandiamide, organic acid hydrazide compounds, polyamides, polyamines, phenolic, polyesters, polyisocyanates, polymercaptans, substituted guanidines, urea formaldehyde and melamine formaldehyde resins, and mixtures thereof.

In certain embodiments, the first hardener [B-1] is preferably an aromatic amine compound and preferably has one to four phenyl groups in the molecule with the objective of improving heat resistance and mechanical properties. Furthermore, since a molecular backbone having a bent structure can contribute to an increase in the resin's elastic modulus and improvement in mechanical properties, the first hardener is preferably an aromatic amine compound in which at least one phenyl group present in the backbone has an amino group at an ortho or meta position.

In another embodiment, with the objective of improving heat resistance, an aromatic amine compound in which two or more phenyl groups have amino groups at the para position is preferred.

Examples of such aromatic amine compounds include, but are not limited to, meta-phenylene diamine, diaminodiphenyl methane, diaminodiphenyl sulfone, meta-xylylene diamine, (para-phenylene methylene) dianiline, various derivatives thereof such as alkyl-substituted derivatives, and various isomers having amino groups at different positions. To generate materials suitable for spacecraft and aircraft, in particular, the use of 4,4′-diaminodiphenyl sulfone or 3,3′-diaminodiphenyl sulfone is preferred because these compounds result in cured products exhibiting high heat resistance and elastic modulus while not significantly suffering from a decrease in linear expansion coefficient or a reduction in heat resistance due to moisture absorption. These aromatic amine compounds may be used singly or two or more may be used in combination. When mixed with other components, they may be in powder or liquid form, or powdered and liquid aromatic amine compounds may be mixed together.

Specific examples of suitable aromatic amine compounds include, but are not limited to, SEIKACURE-S (manufactured by Seika K.K.), ARADUR® 976-1, ARADUR® 9664-1, ARADUR® 9719-1 (all manufactured by Huntsman Corporation), 3,3′-DAS (manufactured by Mitsui Chemicals, Inc.), LONZACURE® M-DIPA, and LONZACURE® M-MIPA (both manufactured by Lonza).

In certain embodiments, the second hardener [B-2] is preferably an organic acid hydrazide compound with the objective of achieving a balance between latency and reactivity of the epoxy resin composition.

In certain embodiments, the organic acid hydrazide compound preferably has at least one aromatic ring structure in the molecule with the objective of improving heat resistance and mechanical properties.

Non-limiting examples of the organic acid hydrazide compound include carbohydrazides, isophthalic dihydrazide (IDH), phthalic dihydrazide, terephthalic dihydrazide, adipic dihydrazide (ADH), dodecanedioic dihydrazide (DDH), 3-hydroxy-2-naphthoic acid hydrazide, 2,6-naphthalenedicarbodihydrazide (NDH), 1,2,3-benzenetricarboxic trihydrazide, aromatic monohydrazides, benzoic acid hydrazide, aliphatic monohydrazides, aliphatic dihydrazides, sebaic acid dihydrazide, aliphatic trihydrazides, aliphatic tetrahydrazides, aromatic monohydrazides, aromatic dihydrazides, aromatic trihydrazides, and aromatic tetrahydrazides.

Specific examples of the organic acid hydrazide compound include, but are not limited to, IDH, 3-hydroxy-2-naphthoic acid hydrazide (both manufactured by Otsuka Chemical Co., Ltd.), Technicure® ADH, Technicure® DDH-S (both manufactured by A&C Catalysts, Inc.), and 2,6-naphthalenedicarbodihydrazide (manufactured by Japan Finechem Inc.).

In another embodiment, the melting point of the organic acid hydrazide compound in the present invention may be 185° C. or more, such as 190° C. or more, such as 195° C. or more, such as 200° C. or more, such as 205° C. or more, such as 210° C. or more, such as 215° C. or more, and such as 220° C. or more.

In an embodiment, the component [B-2] is preferably in the form of particles which are insoluble in the component [A] in order to improve thermal stability. Since the component [B-2] is dispersed in the component [A] in an insoluble state, a curing reaction does not significantly proceed until the component [B-2] is dissolved by heating. When the epoxy resin composition is heated at a certain temperature or higher, the component [B-2] is dissolved and initiates a curing reaction with the component [A] together with the component [B-1]. The average particle diameter of the component [B-2] is preferably 100 μm or less, more preferably 50 μm or less, and still more preferably 30 μm or less. Setting the average particle diameter of the component [B-2] to 100 μm or less facilitates dissolution of component [B-2] in curing an epoxy resin, thus improving the curability of the epoxy resin composition. Further, by setting the average particle diameter of the component [B-2] to 100 μm or less, it is possible to suppress any reduction of the desired mechanical properties of the cured resin due to the component [B-2] remaining undissolved. Moreover, the average particle diameter of the component [B-2] is preferably 0.5 μm or more, more preferably 1 μm or more, and still more preferably 2 μm or more. Setting the average particle diameter of the component [B-2] to 0.5 μm or more will suppress reduction of latency due to undesirable dissolution of the component [B-2] into the epoxy resins during the kneading step of a resin or the production step of a prepreg.

The average particle diameter referred to herein is measured with the LA-950 manufactured by HORIBA, Ltd. which uses a laser diffraction scattering method in accordance with ISO 13320:2020(E). The results on a volume basis measured by using ARALDITE® GY282 (component: a bisphenol F type epoxy resin, produced by Huntsman Corporation) as a dispersion medium are employed as a measurement result of a particle size distribution, and a particle diameter at 50% (median diameter) in a cumulative curve of the resulting particle size distribution is used as the average particle diameter.

In certain embodiments, the melting point of the component [B-2] in the present invention is preferably 180° C. or more, such as 200° C. or more, such as 220° C. or more, such as 250° C. or less. When the melting point of the component [B-2] is 180° C. or more, the component [B-2] does not readily dissolve in the component [A], resulting in an improved pot life of the epoxy resin composition during the kneading step of the resin or during the production step of a prepreg. When the pot life is improved, it is possible to suppress defective impregnation of the resin into reinforcing fibers or a reduction of the tackiness properties of a prepreg due to an increase in the viscosity of the resin composition. The pot life referred to herein is the viscosity stability of the epoxy resin composition at a temperature range as low as room temperature to 80° C. The viscosity stability can be identified, for example, by evaluating the viscosity change of the epoxy resin composition after holding at 80° C. for 4 hours by dynamic viscoelasticity measurement. When the melting point of the component [B-2] is more than 250° C., the component [B-2] does not readily dissolve in the component [A] during cure, and therefore the curability of the epoxy resin composition may be undesirably decreased.

Further, the melting point referred to herein can be determined from a peak temperature of a melting curve obtained by raising the temperature from room temperature at a rate of 10° C./min in a differential scanning calorimeter (DSC) in accordance with ASTM D 3418-15.

In an embodiment, the content of the organic acid hydrazide compound may be 1 to 20 parts by mass, preferably 2 to 15 parts by mass, more preferably 3 to 10 parts by mass, relative to 100 parts by mass of the component [A]. By setting the content to 1 part by mass or more, the effect of improving the reactivity of the epoxy resin composition may be achieved. Further, by setting the content to 20 parts by mass or less, it may be possible to suppress undesirable reductions of latency of the epoxy resin composition and heat resistance of the resulting cured epoxy resin composition.

In another embodiment, the equivalent ratio of all active hydrogens of the component [B-1] to all active hydrogens of the component [B-2] is adjusted according to the particular [B-1] and [B-2] hardeners used, but falls within a range of from 1 to 10, such as 2 to 8, such as 3 to 10, such as 1 to 7, such as 1 to 5. A ratio within this range allows the epoxy resin composition to provide a fiber-reinforced composite material having heat resistance and mechanical properties at high level. The equivalent ratio of all active hydrogens of the component [B-1] to all active hydrogens of the component [B-2] was determined from the following equation.

$$\begin{matrix}Equivalent ratio of all active hydrogens \\ of the component [ B ‐ 1 ] to all active \\ hydrogens of the component [ B ‐ 2 ]\end{matrix} = \frac{\begin{matrix}parts by mass of [ B ‐ 1 ] / \\ active hydrogen equivalent weight of [ B ‐ 1 ]\end{matrix}}{\begin{matrix}parts by mass of [ B ‐ 2 ] / \\ active hydrogen equivalent weight of [ B ‐ 2 ]\end{matrix}}$$

In an embodiment, when a combination of an aromatic amine compound and an organic acid hydrazide compound is used as the first hardener [B-1] and the second hardener [B-2], respectively, the equivalent ratio of all active hydrogens of the [B-1] and [B-2] components to all epoxy groups of the component [A] is 0.7 to 1.3, preferably 0.8 to 1.2, more preferably 0.9 to 1.1, with the objective of improving heat resistance and mechanical properties. If the equivalent ratio is less than 0.7, the resulting cured epoxy resin composition may fail to have a sufficiently high crosslinking density, leading to a lack of a suitable elastic modulus and heat resistance, and the resulting fiber-reinforced composite material may fail to exhibit a sufficient static strength property. If the equivalent ratio is more than 1.3, the resulting cured epoxy resin composition may have an excessively high crosslinking density, which leads to a lack of plastic deformation capacity, and the resulting fiber-reinforced composite material may fail to exhibit sufficient impact resistance. As described herein, the phrase “active hydrogen” refers to hydrogen atoms which are covalently bonded to a nitrogen, oxygen or sulfur atom in an organic compound and which participate in a chemical reaction with an epoxy group. For example, the number of active hydrogens of a primary amino group is 2 while the number of active hydrogens of a hydroxyl or thiol group is 1. Since in the hydrazide, only hydrogen atoms coupled with a terminal nitrogen atom contribute to a reaction with an epoxy group, the number of active hydrogens per one hydrazide group is counted as 2. When the equivalent ratio of all active hydrogens of the [B-1] and [B-2] components to all epoxy groups of the component [A] falls within the predetermined range described above, the result is a cured resin which exhibits excellent heat resistance and elastic modulus. The equivalent ratio of all active hydrogens of the [B-1] and [B-2] components to all epoxy groups of the component [A] was determined from the following equations.

$$\\ \begin{matrix}Equivalent ratio of all active hydrogens \\ of the [ B ‐ 1 ] and [ B ‐ 2 ] components to \\ all epoxy groups of [ A ]\end{matrix} = \frac{total equivalents of all active hydrogens of [ B ‐ 1 ] and [ B ‐ 2 ]}{total equivalents of epoxy groups of [ A ]}$$

$$\\ \begin{matrix}Total equivalents of all active \\ hydrogens of [ B ‐ 1 ] and [ B ‐ 2 ]\end{matrix} = \begin{matrix}parts by mass of [ B ‐ 1 ] / active hydrogen equivalent weight of [ B ‐ 1 ] \\ + \\ parts by mass of [ B ‐ 2 ] / active hydrogen equivalent weight of [ B ‐ 2 ]\end{matrix}$$

$$\\ \begin{matrix}Total equivalents of epoxy \\ groups of [ A ]\end{matrix} = \begin{matrix}\begin{matrix}parts by mass of epoxy resin 1 / \\ epoxy equivalent weight of epoxy resin 1\end{matrix} \\ + \\ \begin{matrix}\begin{matrix}parts by mass of epoxy resin 2 / \\ epoxy equivalent weight of epoxy resin 2\end{matrix} \\ + \\ . \\ . \\ + \\ parts by mass of epoxy resin n / \\ epoxy equivalent weight of epoxy resin n\end{matrix}\end{matrix}$$

In the above equations, the “epoxy resin n” represents the n^{th} epoxy resin component of all of the epoxy resin components present as component [A]. For example, when three types of epoxy resins are used in the epoxy resin composition in the present invention, n is 3.

For most commercially available chemical compounds, the active hydrogen equivalent weight of hardener products and the epoxy equivalent weight of epoxy resin products are available from their manufacturers. Even if the equivalent weight of a product is unknown, it can be calculated based on the structural formula if the product is a pure material, or it can be determined from titration if the product is a mixture.

### [C] Accelerator

The component [C] used in the present invention is at least one accelerator that facilitates reaction of an epoxy resin with a hardener.

The choice of accelerators used as the component [C] in the present invention is not limited to any particular accelerator, as long as the relationships (I) described herein are satisfied.

In an embodiment, the component [C] includes accelerators (catalysts) well known in the art, such as amines (such as tertiary amines), organophosphines, heterocyclic nitrogen compounds (such as imidazoles), ammonium salts (such as benzyltrimethylammonium chloride), phosphonium salts (such as ethyltriphenylphosphonium bromide), carboxylic acid salts, arsonium salts, sulfonium salts, and any combination thereof.

In certain embodiments, the component [C] preferably comprises at least one organophosphorus compound as the component [C-1] that accelerates the reaction of the component [A] and at least one hardener.

The choice of the organophosphorus compound used as the component [C-1] in the present invention is not limited to any particular organophosphorus compounds and may depend on the application requirements.

Non-limiting examples of the organophosphorus compounds of the present invention include organophosphines, phosphonium salts, organophosphates, phosphonates, phosphinates, phosphoranes, phosphites, phosphonites, phosphinites, and any combination thereof.

In certain embodiments, the component [C-1] is preferably an organophosphine, with the objective of achieving a balance among latency, reactivity of the epoxy resin composition, and desired mechanical properties of the cured epoxy resin.

Specific examples of the organophosphine compounds include, but are not limited to, triphenylphosphine, tri-o-tolylphosphine, tri-m-tolylphosphine, tri-p-tolylphosphine, tri-2,4-xylylphosphine, tri-2,5-xylylphosphine, tri-3,5-xylylphosphine, tris(p-tert-butylphenyl)phosphine, tris(p-methoxyphenyl)phosphine, tris(o-methoxyphenyl)phosphine, tris(p-tert-butoxyphenyl)phosphine, diphenyl-2-pyridylphosphine, diphenylcyclohexylphosphine, tricyclohexylphosphine, tri-n-butylphosphine, tri-n-octylphosphine, tri-tert-butylphosphine, di-tert-butyl(2-butenyl)phosphine, di-tert-butyl(3-methyl-2-butenyl)phosphine, di-tert-butylphenylphosphine, [4-(n,n-dimethylamino)phenyl]di-tert-butylphosphine, tris(diethylamino)phosphine, triphenylphosphine oxide and triphenylphosphine triphenylborane.

Preferred organophosphine compounds are triphenylphosphine, tri-o-tolylphosphine, tri-m-tolylphosphine, tri-p-tolylphosphine, tris(p-methoxyphenyl)phosphine, diphenylcyclohexylphosphine, triphenylphosphine oxide, and triphenylphosphine triphenylborane.

Specific examples of the phosphonium salts include, but are not limited to, tetraphenylphosphonium bromide, methyltriphenylphosphonium bromide, methyltriphenylphosphonium chloride, ethyltriphenylphosphonium bromide, n-propyltriphenylphosphonium bromide, i-propyltriphenylphosphonium iodide, n-butyltriphenylphosphonium bromide, methoxymethyltriphenylphosphonium chloride, benzyltriphenylphosphonium chloride, 2-carboxyethyltriphenylphosphonium bromide, tetraphenylphosphonium tetraphenylborate, tetraphenylphosphonium tetra-p-tolylborate, tetraphenylphosphonium tetrafluoroborate, p-tolyltriphenylphosphonium tetra-p-tolylborate, tri-tert-butylphosphonium tetraphenylborate, di-tert-butylmethylphosphonium tetraphenylborate, tri-tert-butylphosphonium tetrafluoroborate, di-tert-butyl(methyl)phosphonium tetrafluoroborate, n-butyldi(tert-butyl)phosphonium tetrafluoroborate, di-tert-butyl(2-butenyl)phosphonium tetrafluoroborate, and di-tert-butyl(3-methyl-2-butenyl)phosphonium tetrafluoroborate.

In another embodiment, the amount of the component [C] is 0.1 to 10 parts by mass, such as 0.2 to 5 parts by mass, such as 0.5 to 2 parts by mass, relative to 100 parts by mass of the component [A]. Lower concentrations of the accelerator typically do not provide a sufficient acceleration effect, resulting in significantly diminished reactivity of the epoxy resin compositions. Higher concentrations of the accelerator typically result in undesirably high reactivity and unsuitably low latency of the epoxy resin compositions.

In an embodiment, the melting point of the component [C] is preferably 220° C. or less, when measured by DSC with a heating rate of 10° C./min in accordance with ASTM D 3418-15. When the melting point of the component [C] is 220° C. or less, the component [C] becomes easier to dissolve in the component [A] during curing of the epoxy resin composition, thereby accelerating reaction of the component [A] and at least one hardener. If the melting point of the component [C] is more than 220° C., component [C] may be able to fully dissolve into the component [A] during curing of the epoxy resin composition, resulting in an insufficient acceleration effect.

In another embodiment, the melting point of the component [C] is 200° C. or less, such as 180° C. or less, such as 160° C. or less, such as 140° C. or less, such as 120° C. or less, such as 100° C. or less, such as 80° C. or less.

### Thermoplastic Resin

In certain embodiments of the present invention, mixing or dissolving at least one thermoplastic resin into the above-mentioned epoxy resin composition may be desirable to enhance the properties of the cured epoxy resin composition and of the resulting fiber-reinforced composite material and to increase the minimum viscosity during curing to improve processing characteristics. In general, a thermoplastic resin having chemical bonds selected from the group consisting of carbon-carbon bonds, amide bonds, imide bonds, ester bonds, ether bonds, carbonate bonds, urethane bonds, thioether bonds, sulfone bonds and/or carbonyl bonds in the main chain of the thermoplastic resin is preferred. Further, the thermoplastic resin can also have a partially cross-linked structure and be crystalline or amorphous. In particular, it is suitable or preferred that at least one thermoplastic resin selected from the group consisting of polyamides, polycarbonates, polyacetals, polyphenylene oxides, polyphenylene sulfides, polyallylates, polyesters, polyamideimides, polyimides (including polyimides having a phenyltrimethylindane or phenylindane structure), polyetherimides, polysulfones, polyethersulfones, polyetherketones, polyetheretherketones, polyaramids, polyethernitriles and polybenzimidazoles is mixed or dissolved into the epoxy resin composition.

In an embodiment, it is preferable that the thermoplastic resin is soluble in the epoxy resin used as component [A]. Furthermore, the incorporation of the thermoplastic resin is expected to improve the adhesiveness between the matrix resin and the carbon fiber and accordingly, it is preferable that a thermoplastic resin containing a functional group capable of participating in hydrogen bonding is used as the thermoplastic resin. Examples of such functional groups include hydroxyl groups, amide bonds, sulfonyl groups, carbonyl groups, and carboxyl groups.

The expression “being soluble in an epoxy resin” as used herein refers to a temperature range where a homogeneous phase is formed as a result of mixing the thermoplastic resin with the epoxy resin [A] with subsequent heating and stirring. The expression “forming a homogeneous phase” refers to a state where phase separation is not observed by visual inspection. As long as a homogeneous phase can be formed within a particular temperature range, phase separation may occur at other temperature ranges.

For example, if the thermoplastic resin is dissolvable in an epoxy resin when heated, it can be regarded as “being soluble in the epoxy resin” even if separation occurs upon cooling to 23° C. Dissolution may be confirmed by the following method. Specifically, powder of the thermoplastic resin is mixed with an epoxy resin and maintained for several hours, for example 2 hours, at a constant temperature that is lower than the glass transition temperature of the thermoplastic resin while measuring the viscosity change. It can be determined whether the thermoplastic resin is soluble in the epoxy resin based on if the measured viscosity is larger by 5% or more than the viscosity of the epoxy resin alone heated at the same constant temperature.

Examples of thermoplastic resins having an alcoholic hydroxyl group include polyvinyl acetal resins such as polyvinyl formal and polyvinyl butyral as well as polyvinyl alcohol and phenoxy resins.

Examples of thermoplastic resins having an amide bond include polyamides, polyimides, polyamideimides, and polyvinyl pyrolidone.

Examples of thermoplastic resins having a sulfonyl group include polysulfone and polyethersulfone.

Examples of thermoplastic resins having a carboxyl group include polyesters, polyamides, and polyamideimides. The carboxyl group may be located in the main chain and/or at a chain end.

Examples of thermoplastic resins having a carbonyl group include aromatic polyetherketones such as polyether ether ketone.

The above described thermoplastic resins, polyamides, polyimides, and polysulfones may further contain, in their principal chains, an ether bond or a functional group such as carbonyl group. In the polyamide compounds, the nitrogen atom in the amide group may have a substituent.

Examples of a thermoplastic resin soluble in epoxy resins include thermoplastic resins having polyaryl ether backbones. The use of such a thermoplastic resin having a polyaryl ether backbone controls the tackiness of the resulting prepreg, the fluidity of the matrix resin during heat-curing of the prepreg, and provides a tough fiber-reinforced composite material without impairing the heat resistance or elastic modulus.

Examples of thermoplastic resins having a polyaryl ether backbone include polysulfone, polyphenyl sulfone, polyethersulfone, polyetherimide, polyphenylene ether, polyether ether ketone, and polyether ether sulfone, where these thermoplastic resins may be used singly or as a mixture of two or more thereof.

To ensure high heat resistance, the thermoplastic resin having a polyaryl ether backbone preferably has a glass transition temperature (Tg) of at least 150° C. or more, more preferably 170° C. or more. If the glass transition temperature of the thermoplastic resin having a polyaryl ether backbone is less than 150° C., moldings produced therefrom may be subject to thermal deformation. The glass transition temperature of the thermoplastic resin is determined by performing differential scanning calorimetry in the temperature range of 0° C. to 350° C. at a heating rate of 10° C./min and calculating the midpoint temperature according to ES K7121-1987.

The terminal functional group in the thermoplastic resin having a polyaryl ether backbone is preferably a hydroxyl group, a carboxyl group, a thiol group, an anhydride, etc. because these groups can react with a cation-polymerizable compound.

Specific examples of a thermoplastic resin having a polyaryl ether backbone and also having such a terminal functional group include polyethersulfones such as SUMIKAEXCEL® PES3600P, SUMIKAEXCEL® PES5003P, SUMIKAEXCEL® PES5200P, and SUMIKAEXCEL® PES7200P (all manufactured by Sumitomo Chemical Co., Ltd.); and Virantage® VW-10200RFP, Virantage® VW-10300FP, and Virantage® VW-10700RFP (all manufactured by Solvay); and also include copolymer oligomers of polyethersulfone and polyether ether sulfone as described in PCT International Publication WO 2002/016456 A2; and commercial products of polyetherimide such as Ultem® 1000, Ultem® 1010, and Ultem® 1040 (all manufactured by SABIC). An oligomer as referred to herein is a polymer composed of a finite number, commonly 10 to 100, of monomers bonded to each other.

In certain embodiments, the use of polysulfones or polyethersulfones is preferred with the objective of achieving solubility in epoxy resins and improving heat resistance, solvent resistance, and toughness.

There are no specific limitations regarding the weight-average molecular weight of the thermoplastic resin, but it is preferably in the range of 2,000 to 60,000 g/mol, more preferably 10,000 to 55,000 g/mol, still more preferably 15,000 to 50,000 g/mol, and particularly preferably 15,000 to 30,000 g/mol. If the weight-average molecular weight of the thermoplastic resin is less than 2,000 g/mol, any improvement in mechanical properties will be slight and the heat resistance of the epoxy resin composition will suffer. If the weight-average molecular weight of the thermoplastic resin is greater than 60,000 g/mol, compatibility with the epoxy resin composition may be poor, and no improvement in mechanical properties will be obtained in the cured epoxy resin composition or the fiber-reinforced composite material. In addition, when such a thermoplastic resin is dissolved in the epoxy resin, the resulting viscosity may be too high even when blended in small amounts, and the tackiness and draping properties will decline when producing prepregs. When the thermoplastic resin having a weight-average molecular weight of 2,000 to 60,000 g/mol is used, the result is improved compatibility with the epoxy resin composition and improved mechanical properties without compromising the heat resistance properties of the epoxy resin composition. Moreover, suitable tackiness and draping properties are achieved when producing prepregs.

Determination of the weight-average and number-average molecular weights of components used in this invention can be obtained by gel permeation chromatography (“GPC”). The number-average molecular weight of a monomer corresponds to the molecular weight of one monomer unit. Examples of the method for measuring the weight-average and the number-average molecular weight include a method wherein two Shodex 80M® [columns] (manufactured by Showa Denko) and one Shodex 802® [column] (manufactured by Showa Denko) are used, 0.3 μL of sample is injected, and the retention time of the sample measured at a flow rate of 1 mL/min is converted to molecular weight by utilizing the retention time of a calibration sample composed of polystyrene. When multiple peaks are observed in liquid chromatography, the target components are separated beforehand by liquid chromatography, and each component is then subjected to GPC, followed by molecular weight conversion.

Although the epoxy resin composition need not contain a thermoplastic resin, in various embodiments of the invention the epoxy resin composition is comprised of at least 1, at least 5, or at least 10 parts by mass of a thermoplastic resin. For example, a thermoplastic resin accounts for 1 to 30 parts by mass relative to 100 parts by mass of the component [A]. By setting the amount of the thermoplastic resin to such a range, it is possible to provide a balance between the viscosity of the epoxy resin composition, the tackiness properties of the resulting prepreg, and the mechanical properties of the resulting fiber-reinforced composite material.

In an embodiment, the epoxy resin composition of the present invention may include thermoplastic resin particles within a range that does not lower significantly the heat resistance and the curability of the epoxy resin composition. The thermoplastic resin particles are used to add to the impact resistance of the fiber-reinforced composite material. The fiber-reinforced composite material generally assumes a laminate structure, and when an impact occurs to the structure, high stress is generated between the laminate layers that causes delamination damage. To improve the resistance of the fiber-reinforced composite material to such external impact, it is therefore only necessary to improve the toughness of the resin layer formed between the layers including the reinforced fibers (hereinafter, sometimes referred to as the “interlayer resin layer”) of the fiber-reinforced composite material. In the present invention, the toughness of the fiber-reinforced composite material is improved by adding a thermoplastic resin into the epoxy resin composition, and to further selectively increase the toughness of the interlayer resin layer of the fiber-reinforced composite material, thermoplastic resin particles are preferably added.

Examples of the thermoplastic resin particles used in the present invention include the same thermoplastic resins listed previously as exemplary thermoplastic resins intended for use in the epoxy resins. In particular, polyamide particles are particularly preferred because they are so high in toughness that they serve to produce fiber-reinforced composite materials having high impact resistance. Of the various polyamide particle materials, polyamide 12, polyamide 6, polyamide 11, polyamide 66, polyamide 6/12 copolymer, and polyamide polymers modified with an epoxy compound into a semi-IPN structure (semi-IPN polyamide) as described in Example 1 of JP H01104624A can develop particularly high adhesiveness to epoxy resins. Here, IPN stands for “interpenetrating polymer network”, which is a type of polymer blend. Crosslinked polymers are used as blend components and the dissimilar crosslinked polymers are partially or fully entangled to form a multiple network structure. A semi-IPN has a multiple network formed of crosslinked and straight-chain polymers. Particles containing a semi-IPN thermoplastic resin as the primary component can be produced by, for example, dissolving a thermoplastic resin and a thermosetting resin in a common solvent, mixing them uniformly, and performing reprecipitation, etc. The use of particles of an epoxy resin and a semi-IPN polyamide serves to produce a prepreg having high heat resistance and high impact resistance.

In an embodiment, it is preferred that thermoplastic resin particles are used in an epoxy resin, because the adhesiveness of the epoxy resin composition used as matrix resin increases, which serves to produce a fiber-reinforced composite material having improved impact resistance.

The shape of such thermoplastic resin particles may be spherical, non-spherical, porous, needle-like, whisker-like, or flaky. Spherical particles are preferred because spherical particles do not reduce the flow property of the epoxy resin and accordingly can maintain a good impregnating property into the fiber layer and also because the degree of delamination caused by local impact is further reduced in a drop impact (or local impact) test of a fiber-reinforced composite material so that, in the case where a stress is applied to the fiber-reinforced composite material after undergoing an impact, there will be a decreased number of delaminated portions resulting from the local impact and acting as starting points of destruction attributed to stress concentration, thereby making it possible to obtain a fiber-reinforced composite material having high impact resistance.

Specific examples of polyamide particles include SP-500, SP-10, TR-1, and TR-2 (all manufactured by Toray Industries, Inc.), Orgasol® 1002D, Orgasol® 2001UD, Orgasol® 2001EXD, Orgasol® 2002D, Orgasol® 3202D, Orgasol® 3501D, and Orgasol® 3502D (all manufactured by Arkema).

In an embodiment, some types of thermoplastic particles have a higher modification effect because they are not dissolved in the matrix resin during the curing step. The feature of not being dissolved during the curing step is also effective for maintaining fluidity of the resin during the curing step and improving the impregnating property. Therefore, particles that are not dissolved in the matrix resin during the curing step are preferred for use as the aforementioned thermoplastic resin particles.

In an embodiment, the epoxy resin composition of the present invention may include rubber particles to further enhance the high impact resistance of a fiber-reinforced composite material obtained by curing the prepreg according to the present invention.

The rubber particles to be used for the present invention may be made of a natural rubber or synthetic rubber. In particular, particles of a crosslinked rubber that are insoluble in epoxy resins are preferred. If the rubber particles are insoluble in the epoxy resin, the cured product will have nearly the same heat resistance as that of the cured product of the epoxy resin free of the particles. Furthermore, changes in morphology will not occur depending on the difference in the type or curing conditions of the thermosetting resin and therefore, the cured thermosetting resin will have stable physical properties such as toughness. Preferred crosslinked rubber particles include, for example, particles of a copolymer with one or a plurality of unsaturated compounds and particles produced through copolymerization between one or a plurality of unsaturated compounds and crosslinkable monomers.

Examples of such unsaturated compounds include aliphatic olefins such as ethylene and propylene; aromatic vinyl compounds such as styrene and methyl styrene; conjugated diene compounds such as butadiene, dimethyl butadiene, isoprene, and chloroprene; unsaturated carboxylates such as methyl acrylate, propyl acrylate, butyl acrylate, methyl methacrylate, propyl methacrylate, and butyl methacrylate; and vinyl cyanides such as acrylonitrile.

Furthermore, it may also be effective to use compounds having a carboxyl group, epoxy group, hydroxyl group, amino group, amide group, or other functional groups that are reactive with epoxy resins or curing agents. Preferred ones include acrylic acid, glycidyl methacrylate, vinyl phenol, vinyl aniline, and acrylamide.

Preferred examples of such crosslinkable monomers include compounds having a plurality of polymerizable double bonds in one molecule, such as divinylbenzene, diallylphthalate, and ethylene glycol dimethacrylate.

These particles can be produced by known conventional polymerization methods including, for example, emulsion polymerization and suspension polymerization. A typical emulsion polymerization process includes a step for emulsion polymerization of an unsaturated compound, crosslinkable monomers, etc., in the presence of a radical polymerization initiator such as a peroxide, a molecular weight adjustor such as a mercaptan and halogenated hydrocarbon, and an emulsifier, a step for adding a reaction terminator to stop the polymerization reaction after reaching a predetermined degree of polymerization conversion, and a subsequent step for water vapor distillation to remove unreacted monomers from the polymerization system, thereby providing a latex of a copolymer. Water is removed from such a latex obtained by emulsion polymerization to provide crosslinked rubber particles.

Examples of such crosslinked rubber particles include crosslinked acrylonitrile butadiene rubber particles, crosslinked styrene butadiene rubber particles, acrylic rubber particles, and core shell rubber particles. Core shell type rubber particles are in the form of spherical polymer particles in which the central part and the surface part are formed from different polymers and may have a simple two phase structure consisting of a core phase and a single shell phase or a multiple layered structure (multiple core shell rubber particles) having a plurality of shell phases and consisting of, for example, a soft core, hard shell, soft shell, and hard shell located in this order from center to surface. Here, a soft phase means a phase of a rubber as described above whereas a hard phase means a phase of a resin that is not rubber. These different types of crosslinked rubber particles may be used singly or as a combination of two or more thereof.

The epoxy resin composition may contain thermosetting resin particles, and inorganic fillers such as silica gel, carbon black, clay, carbon nanotube, carbon particles, and metal powder, unless they impair the advantageous effects of the invention. Examples of carbon black include channel black, thermal black, furnace black, and ketjen black.

In certain embodiments, when the epoxy resin composition is used as a matrix resin of a prepreg, the initial viscosity at 80° C. of the epoxy resin composition is preferably in the range of 0.5 to 400 Pa·s. Herein, the initial viscosity at 80° C. refers to the viscosity measured after being held at 80° C. for 1 minute (V₁) by the method described below. When the initial viscosity at 80° C. is 0.5 Pa·s or more, an excessive resin flow rarely occurs in molding a fiber-reinforced composite material and undesired variations in the reinforcing fiber content may be suppressed. Furthermore, when the initial viscosity at 80° C. is 0.5 Pa·s or more, powder components in the epoxy resin composition are not undesirably precipitated during molding the fiber-reinforced composite material and are uniformly dispersed, and therefore a fiber-reinforced composite material having good uniformity can be obtained. When the initial viscosity at 80° C. is 400 Pa·s or less, the epoxy resin composition can be adequately impregnated into the reinforcing fibers when producing the prepreg and voids are rarely generated in the resulting fiber-reinforced composite material, and therefore a reduction in strength of the fiber-reinforced composite material may be suppressed. The initial viscosity at 80° C. of the epoxy resin composition is preferably in the range of 0.5 to 400 Pa·s, more preferably in the range of 1 to 200 Pa·s, still more preferably in the range of 5 to 150 Pa·s, and particularly preferably in the range of 5 to 100 Pa·s so that in a prepreg production step, the epoxy resin composition is easily impregnated into the reinforced fibers and a prepreg having a high fiber mass content is produced.

To have excellent latency with excellent curability, it is essential for the epoxy resin composition according to the present invention to satisfy the relationships between T₁ and T₂ as defined in (I). If the epoxy resin composition satisfies the relationship between T₁ and T₂ as defined in (I), the reaction between the component [A] and the component [B-1] is not substantially accelerated by the component [C], resulting in a cured resin with an excellent Tg. In addition, if the epoxy resin composition satisfies the relationship between T₃ and T₄ as defined in (II), the reaction between the component 5 [A] and the component [B-2] is accelerated by the component [C]. If T₃−T₄ is less than 5.0, the reaction between the component [A] and the component [B-2] is not significantly accelerated.

5.0>|T₁−T₂| (I)

5.0≤T₃−T₄ (II)

T₄ is always lower than T₃ when [C] accelerates the reaction between component [A] and component [B-2]. If T₃−T₄ is an absolute value, the situation is included where [C] actually decelerates the reaction between [A] and [B-2], that is, T₄>T₃. Therefore, satisfaction of relationships (I) and (II) by the epoxy resin composition means the component [C] possesses a selective ability to accelerate the reaction between the component [A] and the component [B-2] in the epoxy resin composition comprising the components [A], [B-1], [B-2], and [C], resulting in an epoxy resin composition exhibiting excellent latency with excellent curability.

In the relationships (I) and (II), T₁ is the extrapolated onset temperature (° C.) for reaction of a mixture of [A] and [B-1], T₂ is the extrapolated onset temperature (° C.) for reaction of a mixture of [A], [B-1], and [C], T₃ is the extrapolated onset temperature (° C.) for reaction of a mixture of [A] and [B-2], and T₄ is the extrapolated onset temperature (° C.) for reaction of a mixture of [A], [B-2], and [C]. The extrapolated onset temperature is determined by differential scanning calorimetry with a heating rate of 10° C./min using the mixtures described herein in the “Examples” section wherein the total number of active hydrogens of [B-1] or [B-2] is 1.0 equivalent relative to 1.0 equivalent of the total number of epoxy groups in [A] and the mass ratio of [C] to [A] is 1:100. Furthermore, the “|T₁−T₂|” as used herein refers to the absolute value of the difference between T₁ and T₂.

In certain embodiments, it is preferable that the |T₁−T₂| is less than 3.0, more preferably less than 2.0, and still more preferably less than 1.0.

In another embodiment, it is preferable that the T₃−T₄ is 7.0 or more, more preferably 10.0 or more, still more preferably 12.0 or more, and particularly preferable 15.0 or more.

In an embodiment, the epoxy resin composition may satisfy the relationships (III) and (IV) between T₁ₚ, T₂ₚ, T₃ₚ and T₄ₚ. If the epoxy resin composition satisfies (III), the reaction between the component [A] and the component [B-1] will not significantly be accelerated by the component [C], resulting in a cured resin with an excellent Tg. On the other hand, if the epoxy resin composition satisfies (IV), the reaction between the component [A] and the component [B-2] will be accelerated by the component [C]. If T₃ₚ−T₄ₚ is less than 3.0, the reaction between the component [A] and the component [B-2] is not significantly accelerated. If the epoxy resin composition satisfies (III) and (IV), the component [C] may show an ability to selectively accelerate more effectively.

2.0>|T₁ₚ−T₂ₚ| (III)

3.0≤T₃ₚ−T₄ₚ (IV)

In the defined relationships in (III) and (IV), T₁ₚ is the peak temperature (° C.) for reaction of a mixture of [A] and [B-1], T₂ₚ is the peak temperature (° C.) for reaction of a mixture of [A], [B-1], and [C], T₃ₚ s the peak temperature (° C.) for reaction of a mixture of [A] and [B-2], and T₄ₚ is the peak temperature (° C.) for reaction of a mixture of [A], [B-2], and [C]. The peak temperature is determined by differential scanning calorimetry with a heating rate of 10° C./min using the mixtures described herein in the “Examples” section wherein the equivalent ratio of all active hydrogens of the component [B-1] or [B-2] to all epoxy groups of the component [A] is 1.0 and the mass ratio of [C] to [A] is 1:100. Furthermore, the “|T₁ₚ−T₂ₚ|” as used herein refers to the absolute value of the difference between T₁ₚ and T₂ₚ. The equivalent ratio of all active hydrogens of the component [B-1] or [B-2] to all epoxy groups of the component [A] was determined from the following equations.

$$\\ \begin{matrix}Equivalent ratio of all active \\ hydrogens of [ B ‐ 1 ] or [ B ‐ 2 ] to \\ all epoxy groups of [ A ]\end{matrix} = \frac{equivalents of all active hydrogens of [ B ‐ 1 ] or [ B ‐ 2 ]}{total equivalents of epoxy groups of [ A ]}$$

$$\\ \begin{matrix}Equivalents of all active \\ hydrogens of [ B ‐ 1 ] or [ B ‐ 2 ]\end{matrix} = \begin{matrix}parts by mass of [ B ‐ 1 ] / active hydrogen equivalent weight of [ B ‐ 1 ] \\ or \\ parts by mass of [ B ‐ 2 ] / active hydrogen equivalent weight of [ B ‐ 2 ]\end{matrix}$$

$$\\ \begin{matrix}Total equivalents of epoxy \\ groups of [ A ]\end{matrix} = \begin{matrix}\begin{matrix}parts by mass of epoxy resin 1 / \\ epoxy equivalent weight of epoxy resin 1\end{matrix} \\ + \\ \begin{matrix}\begin{matrix}parts by mass of epoxy resin 2 / \\ epoxy equivalent weight of epoxy resin 2\end{matrix} \\ + \\ . \\ . \\ + \\ parts by mass of epoxy resin n / \\ epoxy equivalent weight of epoxy resin n\end{matrix}\end{matrix}$$

In the above equations, the “epoxy resin n” represents the n^{th} epoxy resin component in all the epoxy resin components [A]. For example, when three types of epoxy resins are used for the epoxy resin composition in the present invention, n is 3.

In certain embodiments, the |T₁ₚ−T₂ₚ| may be less than 1.5, in another embodiment less than 1.0, and in still another embodiment less than 0.5.

In another embodiment, the T₃ₚ−T₃ₚ may be 5.0 or more, in another embodiment 7.0 or more, and in still another embodiment 10.0 or more.

In an embodiment, the component [C-1] results in the epoxy resin composition satisfying the following relationships (V) and (VI):

5.0>|T₁−T₅| (V)

2.0>|T₁ₚ−T₅ₚ| (VI)

In (V) and (VI), T₁ is the onset temperature (° C.) for reaction of a mixture of [A] and [B-1]; T₅ is the onset temperature (° C.) for reaction of a mixture of [A], [B-1], and [C-1]; T₁ₚ is the peak temperature (° C.) for reaction of a mixture of [A] and [B-1]; T₅ₚ is the peak temperature (° C.) for reaction of a mixture of [A], [B-1], and [C-1]. The onset temperature and the peak temperature are determined by differential scanning calorimetry (DSC) with a heating rate of 10° C./min using the mixtures described herein in the “Examples” section wherein the equivalent ratio of all active hydrogens of the component [B-1] or [B-2] to all epoxy groups of the component [A] is 1.0 and the mass ratio of [C-1] to [A] is 1:100. Furthermore, the “|T₁−T₅|” and “|T₁ₚ−T₅ₚ|” as used herein refers to the absolute value of the difference between T₁ and T₅, and T₁ₚ and T₅ₚ, respectively. The equivalent ratio of all active hydrogens of the component [B-1] or [B-2] to all epoxy groups of the component [A] was determined from the following equations.

$$\\ \begin{matrix}Equivalent ratio of all active \\ hydrogens of [ B ‐ 1 ] or [ B ‐ 2 ] to \\ all epoxy groups of [ A ]\end{matrix} = \frac{equivalents of all active hydrogens of [ B ‐ 1 ] or [ B ‐ 2 ]}{total equivalents of epoxy groups of [ A ]}$$

$$\\ \begin{matrix}Equivalents of all active \\ hydrogens of [ B ‐ 1 ] or [ B ‐ 2 ]\end{matrix} = \begin{matrix}parts by mass of [ B ‐ 1 ] / active hydrogen equivalent weight of [ B ‐ 1 ] \\ or \\ parts by mass of [ B ‐ 2 ] / active hydrogen equivalent weight of [ B ‐ 2 ]\end{matrix}$$

$$\\ \begin{matrix}Total equivalents of epoxy \\ groups of [ A ]\end{matrix} = \begin{matrix}\begin{matrix}parts by mass of epoxy resin 1 / \\ epoxy equivalent weight of epoxy resin 1\end{matrix} \\ + \\ \begin{matrix}\begin{matrix}parts by mass of epoxy resin 2 / \\ epoxy equivalent weight of epoxy resin 2\end{matrix} \\ + \\ . \\ . \\ + \\ parts by mass of epoxy resin n / \\ epoxy equivalent weight of epoxy resin n\end{matrix}\end{matrix}$$

In the above equations, the “epoxy resin n” represents the n th epoxy resin component in all the components [A]. For example, when three types of epoxy resins are used for the epoxy resin composition in the present invention, n is 3.

When the epoxy resin composition satisfies the relationships (V) and (VI), the likely result is excellent latency with excellent curability and a cured resin with an excellent Tg. This outcome may be possible because the component [C-1] accelerates the reaction between the component [A] and the component [B-2] but not (significantly) the reaction between the component [A] and the component [B-1]. Since the latter reaction tends to lead to less latency than the former reaction, accelerating only the former reaction should be favorable for achieving excellent latency with excellent curability.

In certain embodiments, it is preferable that the |T₁−T₅| is less than 3.0, more preferably less than 2.0, and still more preferably less than 1.0.

In another embodiments, the |T₁ₚ−T₅ₚ| may be less than 1.5, in another embodiment less than 1.0, and in still another embodiment less than 0.5.

In an embodiment, the ratio (V₂/V₁) of the viscosity of the epoxy resin composition measured after being held at 80° C. for 4 hours (V₂) to the viscosity measured after being held at 80° C. for 1 minute (V₁) is 2.5 or less, preferably 2.0 or less, more preferably 1.6 or less, and still more preferably 1.2 or less. The V₂/V₁ ratio which reflects the magnification of thickening at 80° C. can be used as an index of pot life of an epoxy resin composition in the kneading step or in the production step of a prepreg. That is, the smaller V₂/V₁ ratio results in a good pot life at a temperature of 80° C. or lower. When the V₂/V₁ ratio is 2.5 or less, the latency of the epoxy resin composition is high and the impregnating property of the resin into reinforcing fibers is not deteriorated in a prepreg production step which results in minimizing the presence of voids in a molded article.

The viscosities of the epoxy resin composition after being held at 80° C. for 1 minute (V₁) and for 4 hours (V₂) are measured using a dynamic viscoelasticity measuring 10 device (ARES, manufactured by TA Instruments) equipped with parallel plates with diameters of 40 mm (top) and 50 mm (bottom), which was operated under the conditions of a parallel plate gap of 0.6 mm, an angular frequency of 10 rad/s, a strain of 10%, and a measurement temperature of 80° C. in accordance with ASTM D 4473-95a.

### Prepreg/Fiber-Reinforced Composite Material

The prepreg of the present invention is prepared by impregnating reinforcing fibers with the as described epoxy resin compositions as matrix resins. Preferred examples of the reinforced fibers include carbon fibers, graphite fibers, aramid fibers, glass fibers and the like, and among these fibers, carbon fibers are particularly preferred.

The prepreg can be prepared by various commonly known methods, for example, by a wet method of dissolving a matrix resin in a solvent such as methyl ethyl ketone and methanol to reduce the viscosity of the resin and then impregnating reinforcing fiber bundles with the solution, or by a hot melting method of heating a matrix resin to reduce the viscosity of the resin and then impregnating reinforcing fiber bundles with the resin.

In the wet method, the prepreg is prepared by immersing sizing agent-coated carbon fiber bundles in a solution containing a matrix resin, then pulling up the reinforcing fiber bundles, and evaporating the solvent using an oven or other units.

In the hot melting method, a prepreg is prepared by a method of directly impregnating reinforcing fiber bundles with a matrix resin having a viscosity lowered by heat or alternatively, by a method of preparing a coating film of a matrix resin composition on a release paper or the like, followed by superimposing the film on each side or on one side of the reinforcing carbon fiber bundles, and then applying heat and pressure to the film to impregnate the reinforcing fiber bundles with the matrix resin. The hot melting method is preferred over the wet method because no solvent remains in the prepreg.

The reinforcing fiber cross-sectional density of a prepreg may be 50 to 1000 g/m², such as 100 to 1000 g/m², such as 200 to 1000 g/m². If the cross-sectional density is at least 50 g/m², there may be a need to laminate a small number of prepregs to secure the predetermined thickness when molding a fiber-reinforced composite material which may simplify the lamination process. If, on the other hand, the cross-sectional density is no more than 1000 g/m², the drapability of the prepreg remains good. The reinforcing fiber mass fraction of a prepreg may be 40 to 90% by mass in some embodiments, 50 to 85% by mass in other embodiments or even 60 to 80% by mass in still other embodiments. If the reinforcing fiber mass fraction is at least 40% by mass, there is sufficient fiber content to provide a fiber-reinforced composite material with excellent specific strength and specific modulus, as well as preventing the fiber-reinforced composite material from generating too much heat during the curing time. If the reinforcing fiber mass fraction is no more than 90% by mass, impregnation of the reinforcing fibers with the resin decreases the risk of a large number of voids forming in the fiber-reinforced composite material.

The method for forming a fiber-reinforced composite material by using a prepreg of the present invention is exemplified by a method of stacking prepregs and thermally hardening a matrix resin while applying pressure to the laminate.

Application of heat and pressure under the prepreg lamination and molding method may be achieved by using a press molding method, an autoclave molding method, a bagging molding method, a wrapping tape method, an internal pressure molding method, or the like as appropriate.

Autoclave molding is a method in which prepregs are laminated on a tool plate of a predetermined shape and then covered with bagging film, followed by curing, performed through the application of heat and pressure while air is drawn out of the laminate. This method allows precision control of the fiber orientation, as well as providing high-quality molded materials with excellent mechanical characteristics, due to a minimum void content. The pressure applied during the molding process may be 0.3 to 1.0 MPa, while the molding temperature may be in a range of 90 to 300° C.

The wrapping tape method is a method in which prepregs are wrapped around a mandrel or some other cored bar to form a tubular fiber-reinforced composite material. This method may be used to produce golf shafts, fishing poles and other rod-shaped products. More specifically, the method involves the wrapping of prepregs around a mandrel using a wrapping tape made of thermoplastic film to wrap over the prepregs under tension for the purpose of securing the prepregs and applying pressure to them. After curing of the resin through heating inside an oven, the mandrel is removed to obtain a tubular body. The tension used to wrap the wrapping tape may be 20 to 100 N. The molding temperature may be in a range of 80 to 300° C.

The internal pressure forming method is a method in which a preform obtained by wrapping prepregs around a thermoplastic resin tube or some other internal pressure applicator is set inside a metal mold, followed by the introduction of a high pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be in a range of 0.1 to 2.0 MPa. The molding temperature may be in a range between room temperature and 300° C. or in a range of 180 to 275° C.

The fiber-reinforced composite material produced from the prepreg of the present invention may have a class A surface as described herein. The term “class A surface” refers to a surface that exhibits extremely high finish quality characteristics free of aesthetic blemishes and defects.

The fiber-reinforced composite materials that contain the cured epoxy resin compositions obtained from curing the epoxy resin compositions and the reinforcing fibers as described herein are advantageously used in sports applications, general industrial applications, and aeronautic and space applications. Sports applications in which these materials are advantageously used include, but are not limited to, golf shafts, fishing rods, tennis or badminton rackets, hockey sticks and ski poles. General industrial applications in which these materials are advantageously used include, but are not limited to, structural materials for vehicles (such as automobiles, bicycles, marine vessels and rail vehicles), drive shafts, leaf springs, windmill blades, pressure vessels, flywheels, papermaking rollers, roofing materials, cables, and repair/reinforcement materials.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

Although the invention is illustrated and described herein with reference to specific embodiments, the scope of the invention is not intended to be limited by these embodiments. Rather, various modifications may be made within the scope and range of equivalents of the claims without departing from the invention.

### EXAMPLES

Embodiments of the present invention are now described in more detail by way of examples. The measurement of various properties was carried out using the methods described below. These properties were, unless otherwise noted, measured under environmental conditions comprising a temperature of 23° C. and a relative humidity of 50%. Prepregs were then made from the exemplary resins using a hot melt prepreg method. The components used in the working examples and comparative examples are as follows.

### Component [A]

ARALDITE® MY721 (tetraglycidyl diaminodiphenyl methane, manufactured by Huntsman Corporation, epoxy equivalent weight 114 g/eq)

ARALDITE® MY0510 (tetraglycidyl diaminodiphenyl methane, manufactured by Huntsman Corporation, epoxy equivalent weight 101 g/eq)

EPON™ 825 (bisphenol A type epoxy resin, manufactured by Hexion Inc., epoxy equivalent weight 178 g/eq)

EPICLON® 830 (bisphenol F type epoxy resin, manufactured by DIC Corporation, epoxy equivalent weight 169 g/eq)

EPICLON® 4770 (bisnaphthalene type epoxy resin, manufactured by DIC Corporation, epoxy equivalent weight 205 g/eq)

TOREP® A-204E (diglycidyl-N-phenoxy aniline, manufactured by Toray Fine Chemicals Co., Ltd., epoxy equivalent weight 167 g/eq)

### Component [B-1]

SEIKACURE-S (4,4′-diaminodiphenyl sulfone, manufactured by Seika K.K., active hydrogen equivalent weight 62 g/eq)

ARADUR® 9719-1 (3,3′-diaminodiphenyl sulfone, manufactured by Huntsman Corporation, active hydrogen equivalent weight 62 g/eq)

### Component [B-2]

IDH (isophthalic dihydrazide, manufactured by Otsuka Chemical Co., Ltd., melting point: 220° C., active hydrogen equivalent weight 49 g/eq)

Technicure® ADH (adipic dihydrazide, manufactured by A&C Catalysts, Inc., melting point: 180° C., active hydrogen equivalent weight 29 g/eq)

NDH (2,6-naphthalenedicarbohydrazide, melting point: >220° C., active hydrogen equivalent weight 61 g/eq)

### Component [C]

TBA-OTF (Tetrabutylammonium trifluoromethanesulfonate, manufactured by Sigma-Aldrich, Inc., melting point: 58° C.)

EPTS (Ethyl p-toluenesulfonate, manufactured by Sigma-Aldrich, Inc.) Piperidinium BF₃ (piperidinium trifluoroborate, manufactured by Sigma-Aldrich, Inc.)

San-Aid SI-150 (4-Acetoxyphenyldimethylsulfonium hexafluoroantimonate, manufactured by SANSHIN CHEMICAL INDUSTRY CO., LTD, melting point: 149° C.)

### Component [C-1]

TPP (triphenylphosphine, manufactured by Hokko Chemical Industry Co., Ltd., melting point: 82° C.)

TPP-PB® (tetraphenylphosphonium bromide, manufactured by Hokko Chemical Industry Co., Ltd., melting point: 152° C.)

TPP-S® (triphenylphosphine triphenylborane, manufactured by Hokko Chemical Industry Co., Ltd., melting point: 213° C.)

### Thermoplastic Resin

Virantage® VW-10700RFP (polyethersulfone, manufactured by Solvay, weight-average molecular weight 21,000 g/mol, Tg=220° C.)

### (1) Preparation of Epoxy Resin Composition

Epoxy resins of the component [A] and a thermoplastic resin in the amounts and proportions shown in Tables A1-A4 and B1-B5 were fed into a kneader and heated to 150° C. while mixing, followed by stirring for 1 hour so that the thermoplastic resin was dissolved to form a transparent viscous liquid. This liquid was allowed to cool to 75° C. while mixing and then hardeners of the components [B-1] and [B-2] were added, and then accelerators of the component [C] were added, followed by additional mixing for 30 minutes to provide an epoxy resin composition. Tables A1-A4 and B1-B5 summarize the composition of various exemplary resin compositions and their reaction properties.

### (2) Determination of Extrapolated Onset Temperature and Peak Temperature of Epoxy Resin Composition

The following extrapolated onset temperatures (T₁−T₅) and peak temperatures (T₁ₚ−T₅ₚ) were determined by differential scanning calorimetry (DSC) in accordance with ASTM E 2160-04 (2018).
T₁: the extrapolated onset temperature (° C.) for reaction of a mixture of [A] and [B-1]
T₂: the extrapolated onset temperature (° C.) for reaction of a mixture of [A], [B-1], and [C]
T₃: the extrapolated onset temperature (° C.) for reaction of a mixture of [A] and [B-2]
T₄: the extrapolated onset temperature (° C.) for reaction of a mixture of [A], [B-2], and [C]
T₅: the extrapolated onset temperature (° C.) for reaction of a mixture of [A], [B-1], and [C-1]
T₁ₚ: the peak temperature (° C.) for reaction of a mixture of [A] and [B-1]
T₂ₚ: the peak temperature (° C.) for reaction of a mixture of [A], [B-1], and [C]
T₃ₚ: the peak temperature (° C.) for reaction of a mixture of [A] and [B-2]
T₄ₚ: the peak temperature (° C.) for reaction of a mixture of [A], [B-2], and [C]
T₅ₚ: the peak temperature (° C.) for reaction of a mixture of [A], [B-1], and [C-1]

The aforementioned mixtures were prepared by mixing the components as described below.

### T₁, T₁ₚ, T₂, and T₂ₚ of Working Examples A1-A5

### T₁ and T₁ₚ of Comparative Examples A1-A2

For determination of T₁ and T₁ₚ, 70 parts by mass of ARALDITE® MY721 and 30 parts by mass of TOREP® A-204E as the component [A] were fed into a kneader and heated to 75° C. while mixing, and then 50 parts by mass of SEIKACURE-S as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂ and T₂ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, and T₂ₚ of Working Examples A6-A13 and Comparative Examples A6-A7

### T₁ and T₁ₚ of Comparative Examples A3-A5

For determination of T₁and T₁ₚ, 70 parts by mass of ARALDITE® MY721 and 30 parts by mass of TOREP® A-204E as the component [A] were fed into a kneader and heated to 75° C. while mixing, and then 50 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂ and T₂ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, and T₂ₚ of Working Example A14

### T₁ and T₁ₚ of Comparative Example A8

For determination of T₁ and T₁ₚ, 60 parts by mass of ARALDITE® MY721 and 40 parts by mass of EPON™ 825 as the component [A] were fed into a kneader and heated to 75° C. while mixing, and then 48 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂ and T₂ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, and T₂ₚ of Working Example A15

### T₁ and T₁ₚ of Comparative Example A9

For determination of T₁ and T₁ₚ, 70 parts by mass of ARALDITE® MY721 and 30 parts by mass of EPICLON® 4770 as the component [A] were fed into a kneader and heated to 75° C. while mixing, and then 48 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂ and T₂ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, and T₂ₚ of Working Example A16

### T₁ and T₁ₚ of Comparative Example A10

For determination of T₁ and T₁ₚ, 50 parts by mass of ARALDITE® MY721 and 50 parts by mass of ARALDITE® MY0510 as the component [A] were fed into a kneader and heated to 75° C. while mixing, and then 45 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂ and T₂ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, and T₂ₚ of Working Example A17

### T₁ and T₁ₚ of Comparative Example A11

For determination of T₁ and T₁ₚ, 50 parts by mass of ARALDITE® MY0510 and 50 parts by mass of EPICLON® 830 as the component [A] were fed into a kneader and heated to 75° C. while mixing, and then 45 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂ and T₂ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₃, T₃ₚ, T₄, and T₄ₚ of Working Examples A1-A13 and Comparative Examples A6-A7

### T₃ and T₃ₚ of Comparative Examples A1-A5

For determination of T₃ and T₃ₚ, 70 parts by mass of ARALDITE® MY721 and 30 parts by mass of TOREP® A-204E as the component [A] were fed into a kneader and heated to 75° C. while mixing, and then 40 parts by mass of IDH as the component [B-2] was added, wherein the equivalent ratio of all active hydrogens of the component [B-2] to all epoxy groups of the components [A] was 1.0, followed by additional mixing for 30 minutes to provide a mixture. In the case of determination of T₄ and T₄ₚ, except for having added 1.0 parts by mass of the component [C] after addition of the component [B-2], the same procedure as for the determination of T₃ and T₃ₚ was carried out to provide a mixture, wherein the mass ratio of the component [C] to the component [A] was 1:100.

### T₃, T₃ₚ, T₄, and T₄ₚ of Working Example A14

### T₃ and T₃ₚ of Comparative Example A8

For determination of T₃ and T₃ₚ, 60 parts by mass of ARALDITE® MY721 and 40 parts by mass of EPON™ 825 as the component [A] were fed into a kneader and heated to 75° C. while mixing, and then 38 parts by mass of IDH as the component [B-2] was added, wherein the equivalent ratio of all active hydrogens of the component [B-2] to all epoxy groups of the components [A] was 1.0, followed by additional mixing for 30 minutes to provide a mixture. In the case of determination of T₄ and T₄ₚ, except for having added 1.0 parts by mass of the component [C] after addition of the component [B-2], the same procedure as for the determination of T₃ and T₃ₚ was carried out to provide a mixture, wherein the mass ratio of the component [C] to the component [A] was 1:100.

### T₃, T₃ₚ, T₄, and T₄ₚ of Working Example A15

### T₃ and T₃ₚ of Comparative Example A9

For determination of T₃ and T₃ₚ, 70 parts by mass of ARALDITE® MY721 and 30 parts by mass of EPICLON® 4770 as the component [A] were fed into a kneader and heated to 75° C. while mixing, and then 38 parts by mass of IDH as the component [B-2] was added, wherein the equivalent ratio of all active hydrogens of the component [B-2] to all epoxy groups of the components [A] was 1.0, followed by additional mixing for 30 minutes to provide a mixture. In the case of determination of T₄ and T₄ₚ, except for having added 1.0 parts by mass of the component [C] after addition of the component [B-2], the same procedure as for the determination of T₃ and T₃ₚ was carried out to provide a mixture, wherein the mass ratio of the component [C] to the component [A] was 1:100.

### T₃, T₃ₚ, T₄, and T₄ₚ of Working Example A16

### T₃ and T₃ₚ of Comparative Example A10

For determination of T₃ and T₃ₚ, 50 parts by mass of ARALDITE® MY721 and 50 parts by mass of ARALDITE® MY0510 as the component [A] were fed into a kneader and heated to 75° C. while mixing, and then 36 parts by mass of IDH as the component [B-2] was added, wherein the equivalent ratio of all active hydrogens of the component [B-2] to all epoxy groups of the components [A] was 1.0, followed by additional mixing for 30 minutes to provide a mixture. In the case of determination of T₄ and T₄ₚ, except for having added 1.0 parts by mass of the component [C] after addition of the component [B-2], the same procedure as for the determination of T₃ and T₃ₚ was carried out to provide a mixture, wherein the mass ratio of the component [C] to the component [A] was 1:100.

### T₃, T₃ₚ, T₄, and T₄ₚ of Working Example A17

### T₃ and T₃ₚ of Comparative Example A11

For determination of T₃ and T₃ₚ, 50 parts by mass of ARALDITE® MY0510 and 50 parts by mass of EPICLON® 830 as the component [A] were fed into a kneader and heated to 75° C. while mixing, and then 36 parts by mass of IDH as the component [B-2] was added, wherein the equivalent ratio of all active hydrogens of the component [B-2] to all epoxy groups of the components [A] was 1.0, followed by additional mixing for 30 minutes to provide a mixture. In the case of determination of T₄ and T₄ₚ, except for having added 1.0 parts by mass of the component [C] after addition of the component [B-2], the same procedure as for the determination of T₃ and T₃ₚ was carried out to provide a mixture, wherein the mass ratio of the component [C] to the component [A] was 1:100.

### T₁, T₁ₚ, T₂, T₂ₚ T₅, and T₅ₚ of Working Examples B1-B5, B18

### T₁ and T₁ₚ of Comparative Examples B1-B3, B16

For determination of T₁ and T₁ₚ, 70 parts by mass of ARALDITE® MY721 and 30 parts by mass of TOREP® A-204E as the component [A] were fed into a kneader and heated to 75° C. while mixing, and then 50 parts by mass of SEIKACURE-S as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂, T₂ₚ, T₅ and T₅ₚ except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, T₂ₚ T₅, and T₅ₚ of Working Examples B6-B13 and Comparative Examples B8-B10

### T₁ and T₁ₚ of Comparative Examples B4-B7, B11

For determination of T₁ and T₁ₚ, 70 parts by mass of ARALDITE® MY721 and 30 parts by mass of TOREP® A-204E as the component [A] were fed into a kneader and heated to 75° C. while mixing, and then 50 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂, T₂ₚ, T₅ and T₅ₚ, except for having added 1.0 parts by mass of the component [C] after addition of the component [B-1], the same procedure as for the determination of T₁ and T_{1 p} was carried out to provide a mixture, wherein the mass ratio of the component [C] to the component [A] was 1:100.

### T₁, T₁ₚ, T₂, T₂ₚ T₅, and T₅ₚ of Working Example B14

### T₁ and T₁ₚ of Comparative Example B12

For determination of T₁ and T₁ₚ, 60 parts by mass of ARALDITE® MY721 and 40 parts by mass of EPON™ 825 as the component [A] were fed into a kneader and heated to 75° C. while mixing, and then 48 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂, T₂ₚ, T₅ and T₅ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, T₂ₚ T₅, and T₅ₚ of Working Example B15

### T₁ and T₁ₚ of Comparative Example B13

For determination of T₁ and T₁ₚ, 70 parts by mass of ARALDITE® MY721 and 30 parts by mass of EPICLON® 4770 as the component [A] were fed into a kneader and heated to 75° C. while mixing, and then 48 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂, T₂ₚ, T₅ and T₅ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, T₂ₚ T₅, and T₅ₚ of Working Example B16

### T₁ and T₁ₚ of Comparative Example B14

For determination of T₁ and T₁ₚ, 50 parts by mass of ARALDITE® MY721 and 50 parts by mass of ARALDITE® MY0510 as the component [A] were fed into a kneader and heated to 75° C. while mixing, and then 45 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂, T₂ₚ, T₅ and T₅ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

### T₁, T₁ₚ, T₂, T₂ₚ T₅, and T₅ₚ of Working Example B17

### T₁ and T₁ₚ of Comparative Example B15

For determination of T₁ and T₁ₚ, 50 parts by mass of ARALDITE® MY0510 and 50 parts by mass of EPICLON® 830 as the component [A] were fed into a kneader and heated to 75° C. while mixing, and then 45 parts by mass of ARADUR® 9719-1 as the component [B-1] was added, wherein the equivalent ratio of all active hydrogens of the component [B-1] to all epoxy groups of the components [A] was 1.0, followed by additional mixing for 30 minutes to provide a mixture. In the case of determination of T₂, T₂ₚ, T₅ and T₅ₚ, except for having added 1.0 parts by mass of the component [C] after addition of the component [B-1], the same procedure as for the determination of T₁ and T₁ₚ was carried out to provide a mixture, wherein the mass ratio of the component [C] to the component [A] was 1:100.

After sampling approximately 4 mg specimens of the mixtures, DSC curves of heat flow versus temperature were obtained by placing each specimen in a nitrogen atmosphere in a differential scanning calorimeter (DSC Q200, manufactured by TA Instruments), maintaining the temperature at −50° C. for 1 minute, then heating once over a temperature range up to 325° C. with a ramp rate of 10° C./min. A temperature which corresponds to an intersection point between an extrapolated base line and a tangent line with respect to the point of maximum rate of change, was reported as the extrapolated onset temperature in accordance with ASTM E 2160-04 (2018).

### (3) Determination of Gel Time of Epoxy Resin Composition

The gel time of the epoxy resin composition was determined using Advanced Polymer Analyzer (APA2000, manufactured by ALPHA Technologies), which was operated under the conditions of a die type of parallel plate, a die gap of 2.583 mm, a frequency of 1.67 Hz, and a strain of 0.7%. Measurement temperature was raised at a rate of 1.7° C./min from 40° C. to 105° C., and then held for 12 hours at 105° C. The time to reach the crossover point, i.e., the point where the storage elastic modulus (G′) value became greater than the loss elastic modulus (G″) value, was reported as the gel time in accordance with ASTM D 4473-95a wherein the time to start heating was 0 minutes.

### (4) Measurement of Viscosity (V₁ and V₂) of Epoxy Resin Composition

Viscosities of the epoxy resin composition after being held at 80° C. for 1 minute (V₁) and for 4 hours (V₂) were measured using a dynamic viscoelasticity measuring device (ARES, manufactured by TA Instruments) equipped with parallel plates with diameters of 40 mm (top) and 50 mm (bottom), which was operated under the conditions of a parallel plate gap of 0.6 mm, an angular frequency of 10 rad/s, a strain of 10%, and a measurement temperature of 80° C. in accordance with ASTM D 4473-95a.

### (5) Determination of Melting Point of Component

The melting points of the components [B] and [C] were determined from a peak temperature of a melting curve obtained by DSC using an about 4 mg of each component as a specimen in accordance with ASTM D 3418-15.

### Working Examples A1-A4 and Comparative Example A1

Comparative Example A1 did not contain the component [C], while Working Examples A1-A4 utilized various amounts of the component [C] wherein the epoxy resin compositions satisfied the relationships between T₁, T₂, T₃ and T₄ as defined in (I) and (II). The gel times of Working Examples A1-A4 were shortened by 9% or more compared to Comparative Example A1, while maintaining sufficient latency.

### Working Example A5 and Comparative Example A2

Comparative Example A2 did not contain the component [C], while Working Example A5 utilized the component [C] wherein the epoxy resin composition satisfied the relationships between T₁, T₂, T₃ and T₄ as defined in (I) and (II). The amount of component [B-2] was smaller than that in Working Examples A1-A4 and Comparative Example A1. The gel time of Working Example A5 was shortened by 8% compared to Comparative Example A2, while maintaining sufficient latency.

### Working Examples A6-A9 and Comparative Examples A3-A5

Comparative Examples A3-A5 did not contain the component [C], while Working Examples A6-A9 utilized various amounts of the component [C] wherein the epoxy resin compositions satisfied the relationships between T₁, T₂, T₃ and T₄ as defined in (I) and (II). The component [B-1] was different from the one used in Working Examples A1-A5 and Comparative Examples A1-A2. In Comparative Examples A3-A5, the gel time was not shortened by increasing the amount of the component [B-2]. On the other hand, the gel times of Working Examples A6-A9 were shortened by 5% or more compared to Comparative Examples A3-A5, while maintaining sufficient latency.

### Working Examples A10-A13 and Comparative Examples A3, A6-A7

Comparative Examples A6-A7 utilized various components [C] wherein the epoxy resin compositions did not satisfy the relationships between T₁ and T₂ as defined in (I), while Working Examples A10-A13 utilized the various components [C] wherein the epoxy resin compositions satisfied the relationships between T₁, T₂, T₃ and T₄ as defined in (I) and (II). The gel times of Working Examples A10-A13 were shortened by 12% or more compared to Comparative Example A3, while maintaining sufficient latency. On the other hand, in Comparative Examples A6-A7, a gel time was sufficiently shortened compared to Comparative Example 3 but their latency was significantly worse than that for Working Examples A10-A13.

### Working Examples A14-A17 and Comparative Examples A8-A11

Comparative Examples A14-A17 utilized various components [A] but did not contain the component [C], while Working Examples A14-A17 utilized various components [A] and the component [C] wherein the epoxy resin compositions satisfied the relationships between T₁, T₂, T₃ and T₄ as defined in (I) and (II). The gel times of Working Examples A14-A17 were shortened by 7% or more compared to Comparative Examples A10-A13, respectively, while maintaining sufficient latency.

### Working Examples B1-B4 and Comparative Examples B1, B3

Comparative Examples B1and B3 did not contain the component [C], while Working Examples B1-B4 utilized various amounts of the component [C]. The gel times of Working Examples B1-B4 were shortened by 9% or more compared to Comparative Examples B1 and B3, while maintaining sufficient latency.

### Working Example B5 and Comparative Examples B2, B3

Comparative Examples B2 and B3 did not contain the component [C], while Working Example B5 utilized the component [C]. Herein, the amounts of component [B-2] was smaller than that for Working Examples B1-B4 and Comparative Example B1. The gel times of Working Example B5 was shortened by 8% compared to Comparative Examples B2 and B3, while maintaining sufficient latency.

### Working Examples B6-B9 and Comparative Examples B4-B7

Comparative Examples B4-B7 did not contain the component [C], while Working Examples B6-B9 utilized the component [C]. Herein, the component [B-1] was different from the one used for Working Examples B1-B5 and Comparative Examples B1-B3. In Comparative Examples B5-B7, a gel time was not shortened by increasing the amount of the component [B-2]. On the other hand, the gel times of Working Examples B6-B9 were shortened by 5% or more compared to Comparative Examples B4-B7, while maintaining sufficient latency.

### Working Examples B10-B12 and Comparative Examples B5, B8-B10

Comparative Examples B8-B10 utilized various accelerators other than the components [C], while Working Examples B7-B10 utilized the various components [C]. The gel times of Working Examples B10-B12 were shortened by 19% or more compared to Comparative Example B5, while maintaining sufficient latency. On the other hand, in Comparative Examples B8-B10, a gel time was sufficiently shortened compared to Comparative Example B5 but their latency was much worse than that for Working Examples B10-B12.

### Working Example B13 and Comparative Example B11

Comparative Example B11 did not contain the component [C], while Working Example B13 utilized the component [C]. Herein, the component [B-2] was different from the one used for Working Examples B1-B12 and Comparative Examples B1-B10. The gel times of Working Example B13 was shortened by 3% compared to Comparative Example B11, while maintaining sufficient latency.

### Working Examples B14-B17 and Comparative Examples B12-B15

Comparative Examples B12-B15 utilized the various components [A] but did not contain the component [C], while Working Examples B14-B17 utilized the various components [A] and the component [C]. The gel times of Working Examples B14-B17 were shortened by 7% or more compared to Comparative Examples B12-B15, respectively, while maintaining sufficient latency.

TABLE A1

| | | | WE | WE | WE | WE | CE | WE | CE |
|---|---|---|---|---|---|---|---|---|---|
| | | Units | A1 | A2 | A3 | A4 | A1 | A5 | A2 |
| Component | ARALDITE ® MY721 | Parts | 70 | 70 | 70 | 70 | 70 | 70 | 70 |
| [A] | ARALDITE ® MY0510 | | — | — | — | — | — | — | — |
| | EPON ™ 825 | | — | — | — | — | — | — | — |
| | EPICLON ® 830 | | — | — | — | — | — | — | — |
| | EPICLON ® HP-4770 | | — | — | — | — | — | — | — |
| | TOREP ® A-204E | | 30 | 30 | 30 | 30 | 30 | 30 | 30 |
| Component | SEIKACURE-S | Parts | 35 | 35 | 35 | 45 | 35 | 35 | 35 |
| [B-1] | ARADUR ® 9719-1 | | — | — | — | — | — | — | — |
| Component | IDH | Parts | 8 | 8 | 8 | 12 | 8 | 4 | 4 |
| [B-2] | | | | | | | | | |
| Component | [C-1] TPP | Parts | 0.6 | 0.8 | 1.0 | 1.0 | — | 1.0 | — |
| [C] | [C-1] TPP-PB ® | | — | — | — | — | — | — | — |
| | [C-1] TPP-S ® | | — | — | — | — | — | — | — |
| | TBA-OTF | Parts | — | — | — | — | — | — | — |
| | EPTS | | — | — | — | — | — | — | — |
| | Piperidinium BF₃ | | — | — | — | — | — | — | — |
| Thermoplastic | VW-10700RFP | Parts | 20 | 20 | 20 | 20 | 20 | 20 | 20 |
| Reaction | T₁ | ° C. | 201.4 | 201.4 | 201.4 | 201.4 | 201.4 | 201.4 | 201.4 |
| properties | T₁ₚ | | 249.4 | 249.4 | 249.4 | 249.4 | 249.4 | 249.4 | 249.4 |
| | T₂ | | 200.9 | 200.9 | 200.9 | 200.9 | — | 200.9 | — |
| | T₂ₚ | | 250.3 | 250.3 | 250.3 | 250.3 | — | 250.3 | — |
| | T₁ − T₂ | | 0.5 | 0.5 | 0.5 | 0.5 | — | 0.5 | — |
| | T₃ | ° C. | 195.8 | 195.8 | 195.8 | 195.8 | 195.8 | 195.8 | 195.8 |
| | T₃ₚ | | 201.5 | 201.5 | 201.5 | 201.5 | 201.5 | 201.5 | 201.5 |
| | T₄ | | 171.7 | 171.7 | 171.7 | 171.7 | — | 171.7 | — |
| | T₄ₚ | | 190.6 | 190.6 | 190.6 | 190.6 | — | 190.6 | — |
| | T₃ − T₄ | | 24.2 | 24.2 | 24.2 | 24.2 | — | 24.2 | — |
| | Relationship (I) | — | Y | Y | Y | Y | — | Y | — |
| | Relationship (II) | — | Y | Y | Y | Y | — | Y | — |
| | Gel Time (G′ = G″) | min | 636 | 599 | 567 | 467 | 697 | 825 | 895 |
| | Gel time reduction | % | 9 | 14 | 19 | 33 | Control | 8 | Control |
| | V₁ | Pa · s | 44 | 33 | 33 | 64 | 39 | 47 | 41 |
| | V₂ | Pa · s | 55 | 50 | 54 | 88 | 46 | 64 | 41 |
| | V₂/V₁ | — | 1.2 | 1.5 | 1.6 | 1.4 | 1.2 | 1.4 | 1.0 |

T₁: the extrapolated onset temperature (° C.) for reaction of a mixture of [A] and [B-1]
T₂: the extrapolated onset temperature (° C.) for reaction of a mixture of [A], [B-1], and [C]
T₃: the extrapolated onset temperature (° C.) for reaction of a mixture of [A] and [B-2]
T₄: the extrapolated onset temperature (° C.) for reaction of a mixture of [A], [B-2], and [C]
(I): 5.0 > |T₁ − T₂|
(II): 5.0 ≤ T₃ − T₄
Gel time reduction: Gel time reduction relative to control resin
V₁: Viscosity after being held at 80° C. for 1 minute
V₂: Viscosity after being held at 80° C. for 4 hours
Y means that the example meets the relationship (I) or (II)
N means that the example does not meet the relationship (I) or (II)

TABLE A2

| | | | WE | WE | WE | WE | CE | CE | CE |
|---|---|---|---|---|---|---|---|---|---|
| | | Units | A6 | A7 | A8 | A9 | A3 | A4 | A5 |
| Component | ARALDITE ® MY721 | Parts | 70 | 70 | 70 | 70 | 70 | 70 | 70 |
| [A] | ARALDITE ® MY0510 | | — | — | — | — | — | — | — |
| | EPON ™ 825 | | — | — | — | — | — | — | — |
| | EPICLON ® 830 | | — | — | — | — | — | — | — |
| | EPICLON ® HP-4770 | | — | — | — | — | — | — | — |
| | TOREP ® A-204E | | 30 | 30 | 30 | 30 | 30 | 30 | 30 |
| Component | SEIKACURE-S | Parts | — | — | — | — | — | — | — |
| [B-1] | ARADUR ® 9719-1 | | 35 | 35 | 35 | 35 | 35 | 30 | 25 |
| Component | IDH | Parts | 8 | 8 | 8 | 8 | 8 | 12 | 16 |
| [B-2] | | | | | | | | | |
| Component | [C-1] TPP | Parts | 0.5 | 1.0 | 1.5 | 1.0 | — | — | — |
| [C] | [C-1] TPP-PB ® | | — | — | — | — | — | — | — |
| | [C-1] TPP-S ® | | — | — | — | — | — | — | — |
| | TBA-OTF | Parts | — | — | — | — | — | — | — |
| | EPTS | | — | — | — | — | — | — | — |
| | Piperidinium BF₃ | | — | — | — | — | — | — | — |
| Thermoplastic | VW-10700RFP | Parts | 20 | 20 | 20 | — | 20 | 20 | 20 |
| Reaction | T₁ | ° C. | 192.1 | 192.1 | 192.1 | 192.1 | 192.1 | 192.1 | 192.1 |
| properties | T₁ₚ | | 234.4 | 234.4 | 234.4 | 234.4 | 234.4 | 234.4 | 234.4 |
| | T₂ | | 193.0 | 193.0 | 193.0 | 193.0 | — | — | — |
| | T₂ₚ | | 234.9 | 234.9 | 234.9 | 234.9 | — | — | — |
| | T₁ − T₂ | | −0.9 | −0.9 | −0.9 | −0.9 | — | — | — |
| | T₃ | ° C. | 195.8 | 195.8 | 195.8 | 195.8 | 195.8 | 195.8 | 195.8 |
| | T₃ₚ | | 201.5 | 201.5 | 201.5 | 201.5 | 201.5 | 201.5 | 201.5 |
| | T₄ | | 171.7 | 171.7 | 171.7 | 171.7 | — | — | — |
| | T₄ₚ | | 190.6 | 190.6 | 190.6 | 190.6 | — | — | — |
| | T₃ − T₄ | | 24.2 | 24.2 | 24.2 | 24.2 | — | — | — |
| | Relationship (I) | — | Y | Y | Y | Y | — | — | — |
| | Relationship (II) | — | Y | Y | Y | Y | — | — | — |
| | Gel Time (G′ = G″) | min | 509 | 408 | 331 | 400 | 536 | 541 | 546 |
| | Gel time reduction | % | 5 | 24 | 38 | 25 | Control | −1 | −2 |
| | V₁ | Pa · s | 23 | 27 | 31 | 0.5 | 22 | 15 | 15 |
| | V₂ | Pa · s | 30 | 37 | 61 | 0.7 | 26 | 18 | 17 |
| | V₂/V₁ | — | 1.3 | 1.4 | 2.0 | 1.4 | 1.1 | 1.2 | 1.2 |

T₁: the extrapolated onset temperature (° C.) for reaction of a mixture of [A] and [B-1]
T₂: the extrapolated onset temperature (° C.) for reaction of a mixture of [A], [B-1], and [C]
T₃: the extrapolated onset temperature (° C.) for reaction of a mixture of [A] and [B-2]
T₄: the extrapolated onset temperature (° C.) for reaction of a mixture of [A], [B-2], and [C]
(I): 5.0 > |T₁ − T₂|
(II): 5.0 ≤ T₃ − T₄
Gel time reduction: Gel time reduction relative to control resin
V₁: Viscosity after being held at 80° C. for 1 minute
V₂: Viscosity after being held at 80° C. for 4 hours
Y means that the example meets the relationship (I) or (II)
N means that the example does not meet the relationship (I) or (II)

TABLE A3

| | | | WE | WE | WE | WE | CE | CE |
|---|---|---|---|---|---|---|---|---|
| | | Units | A10 | A11 | A12 | A13 | A6 | A7 |
| Component | ARALDITE ® MY721 | Parts | 70 | 70 | 70 | 70 | 70 | 70 |
| [A] | ARALDITE ® MY0510 | | — | — | — | — | — | — |
| | EPON ™ 825 | | — | — | — | — | — | — |
| | EPICLON ® 830 | | — | — | — | — | — | — |
| | EPICLON ® HP-4770 | | — | — | — | — | — | — |
| | TOREP ® A-204E | | 30 | 30 | 30 | 30 | 30 | 30 |
| Component | SEIKACURE-S | Parts | — | — | — | — | — | — |
| [B-1] | ARADUR ® 9719-1 | | 35 | 35 | 35 | 35 | 35 | 35 |
| Component | IDH | Parts | 8 | 8 | 8 | 8 | 8 | 8 |
| [B-2] | | | | | | | | |
| Component | [C-1] TPP | Parts | — | — | — | — | — | — |
| [C] | [C-1] TPP-PB ® | | 0.6 | 1.0 | — | — | — | — |
| | [C-1] TPP-S ® | | — | — | 1.0 | — | — | — |
| | TBA-OTF | Parts | — | — | — | 1.0 | — | — |
| | EPTS | | — | — | — | — | 1.0 | — |
| | Piperidinium BF₃ | | — | — | — | — | — | 1.0 |
| Thermoplastic | VW-10700RFP | Parts | 20 | 20 | 20 | 20 | 20 | 20 |
| Reaction | T₁ | ° C. | 192.1 | 192.1 | 192.1 | 192.1 | 192.1 | 192.1 |
| properties | T₁ₚ | | 234.4 | 234.4 | 234.4 | 234.4 | 234.4 | 234.4 |
| | T₂ | | 191.1 | 191.1 | 188.4 | 192.7 | 156.2 | 158.3 |
| | T₂ₚ | | 234.7 | 234.7 | 234.4 | 233.0 | 204.3 | 223.1 |
| | T₁ − T₂ | | 1.0 | 1.0 | 3.8 | −0.6 | 36.0 | 33.8 |
| | T₃ | ° C. | 195.8 | 195.8 | 195.8 | 195.8 | 195.8 | 195.8 |
| | T₃ₚ | | 201.5 | 201.5 | 201.5 | 201.5 | 201.5 | 201.5 |
| | T₄ | | 187.2 | 187.2 | 184.9 | 189.6 | 177.7 | 181.2 |
| | T₄ₚ | | 197.6 | 197.6 | 196.4 | 197.2 | 190.3 | 191.6 |
| | T₃ − T₄ | | 8.7 | 8.7 | 10.9 | 6.2 | 18.1 | 14.7 |
| | Relationship (I) | — | Y | Y | Y | Y | N | N |
| | Relationship (II) | — | Y | Y | Y | Y | Y | Y |
| | Gel Time (G′ = G″) | min | 424 | 400 | 432 | 473 | 339 | 387 |
| | Gel time reduction | % | 21 | 25 | 19 | 12 | 37 | 28 |
| | V₁ | Pa · s | 30 | 37 | 49 | 28 | 23 | 25 |
| | V₂ | Pa · s | 40 | 51 | 77 | 30 | 91 | 74 |
| | V₂/V₁ | — | 1.3 | 1.4 | 1.6 | 1.1 | 4.0 | 2.9 |

T₁: the extrapolated onset temperature (° C.) for reaction of a mixture of [A] and [B-1]
T₂: the extrapolated onset temperature (° C.) for reaction of a mixture of [A], [B-1], and [C]
T₃: the extrapolated onset temperature (° C.) for reaction of a mixture of [A] and [B-2]
T₄: the extrapolated onset temperature (° C.) for reaction of a mixture of [A], [B-2], and [C]
(I): 5.0 > |T₁ − T₂|
(II): 5.0 ≤ T₃ − T₄
Gel time reduction: Gel time reduction relative to control resin
V₁: Viscosity after being held at 80° C. for 1 minute
V₂: Viscosity after being held at 80° C. for 4 hours
Y means that the example meets the relationship (I) or (II)
N means that the example does not meet the relationship (I) or (II)

TABLE A4

| | | | WE | CE | WE | CE | WE | CE | WE | CE |
|---|---|---|---|---|---|---|---|---|---|---|
| | | Units | A14 | A8 | A15 | A9 | A16 | A10 | A17 | A11 |
| Component | ARALDITE ® MY721 | Parts | 60 | 60 | 70 | 70 | 50 | 50 | — | — |
| [A] | ARALDITE ® MY0510 | | — | — | — | — | 50 | 50 | 50 | 50 |
| | EPON ™ 825 | | 40 | 40 | — | — | — | — | — | — |
| | EPICLON ® 830 | | — | — | — | — | — | — | 50 | 50 |
| | EPICLON ® HP-4770 | | — | — | 30 | 30 | — | — | — | — |
| | TOREP ® A-204E | | — | — | — | — | — | — | — | — |
| Component | SEIKACURE-S | Parts | — | — | — | — | — | — | — | — |
| [B-1] | ARADUR ® 9719-1 | | 35 | 35 | 35 | 35 | 35 | 35 | 35 | 35 |
| Component | IDH | Parts | 8 | 8 | 8 | 8 | 8 | 8 | 8 | 8 |
| [B-2] | | | | | | | | | | |
| Component | [C-1] TPP | Parts | 1.0 | — | 1.0 | — | 0.2 | — | 0.5 | — |
| [C] | [C-1] TPP-PB ® | | — | — | — | — | — | — | — | — |
| | [C-1] TPP-S ® | | — | — | — | — | — | — | — | — |
| | TBA-OTF | Parts | — | — | — | — | — | — | — | — |
| | EPTS | | — | — | — | — | — | — | — | — |
| | Piperidinium BF₃ | | — | — | — | — | — | — | — | — |
| Thermoplastic | VW-10700RFP | Parts | 15 | 15 | 10 | 10 | 25 | 25 | 25 | 25 |
| Reaction | T₁ | ° C. | 176.4 | 176.4 | 180.4 | 180.4 | 175.2 | 175.2 | 169.6 | 169.6 |
| properties | T₁ₚ | | 222.4 | 222.4 | 223.7 | 223.7 | 223.7 | 223.7 | 215.7 | 215.7 |
| | T₂ | | 176.4 | — | 178.1 | — | 173.4 | — | 170.7 | — |
| | T₂ₚ | | 222.3 | — | 222.9 | — | 223.0 | — | 216.4 | — |
| | T₁ − T₂ | | 0.0 | — | 2.4 | — | 1.7 | — | −1.1 | — |
| | T₃ | ° C. | 192.6 | 192.6 | 194.3 | 194.3 | 180.6 | 180.6 | 184.2 | 184.2 |
| | T₃ₚ | | 199.1 | 199.1 | 200.7 | 200.7 | 186.9 | 186.9 | 190.6 | 190.6 |
| | T₄ | | 176.6 | — | 179.5 | — | 169.6 | — | 175.4 | — |
| | T₄ₚ | | 190.8 | — | 192.3 | — | 180.0 | — | 184.4 | — |
| | T₃ − T₄ | | 16.0 | — | 14.8 | — | 10.9 | — | 8.8 | — |
| | Relationship (I) | — | Y | — | Y | — | Y | — | Y | — |
| | Relationship (II) | — | Y | — | Y | — | Y | — | Y | — |
| | Gel Time (G′ = G″) | min | 313 | 342 | 299 | 337 | 337 | 363 | 263 | 342 |
| | Gel time reduction | % | 8 | Control | 11 | Control | 7 | Control | 23 | Control |
| | V₁ | Pa · s | 9 | 8 | 2 | 17 | 12 | 11 | 7 | 4 |
| | V₂ | Pa · s | 14 | 10 | 3 | 23 | 18 | 17 | 12 | 8 |
| | V₂/V₁ | — | 1.5 | 1.2 | 1.8 | 1.3 | 1.5 | 1.5 | 1.8 | 1.7 |

T₁: the extrapolated onset temperature (° C.) for reaction of a mixture of [A] and [B-1]
T₂: the extrapolated onset temperature (° C.) for reaction of a mixture of [A], [B-1], and [C]
T₃: the extrapolated onset temperature (° C.) for reaction of a mixture of [A] and [B-2]
T₄: the extrapolated onset temperature (° C.) for reaction of a mixture of [A], [B-2], and [C]
(I): 5.0 > |T₁ − T₂|
(II): 5.0 ≤ T₃ − T₄
Gel time reduction: Gel time reduction relative to control resin
V₁: Viscosity after being held at 80° C. for 1 minute
V₂: Viscosity after being held at 80° C. for 4 hours
Y means that the example meets the relationship (I) or (II)
N means that the example does not meet the relationship (I) or (II)

TABLE B1

| | | | WE | WE | WE | WE | CE | WE | CE | CE |
|---|---|---|---|---|---|---|---|---|---|---|
| | | Units | B1 | B2 | B3 | B4 | B1 | B5 | B2 | B3 |
| Component | Araldite ® MY721 | Parts | 70 | 70 | 70 | 70 | 70 | 70 | 70 | 70 |
| [A] | Araldite ® MY0510 | | — | — | — | — | — | — | — | — |
| | Epon ™ 825 | | — | — | — | — | — | — | — | — |
| | EPICLON ® 830 | | — | — | — | — | — | — | — | — |
| | EPICLON ® HP-4770 | | — | — | — | — | — | — | — | — |
| | TOREP ® A-204E | | 30 | 30 | 30 | 30 | 30 | 30 | 30 | 30 |
| Component | SEIKACURE-S | Parts | 35 | 35 | 35 | 45 | 35 | 35 | 35 | 45 |
| [B-1] | Aradur ® 9719-1 | | — | — | — | — | — | — | — | — |
| Component | IDH-S | Parts | 8 | 8 | 8 | 12 | 8 | 4 | 4 | — |
| [B-2] | Technicure ® ADH | | — | — | — | — | — | — | — | — |
| Component | [C-1] TPP | Parts | 0.6 | 0.8 | 1.0 | 1.0 | — | 1.0 | — | — |
| [C] | [C-1] TPP-PB ® | | — | — | — | — | — | — | — | — |
| | [C-1] TPP-S ® | | — | — | — | — | — | — | — | — |
| | EPTS | Parts | — | — | — | — | — | — | — | — |
| | Piperidinium BF₃ | | — | — | — | — | — | — | — | — |
| | San-Aid SI-150 | | — | — | — | — | — | — | — | — |
| Thermoplastic | VW-10700RFP | Parts | 20 | 20 | 20 | 20 | 20 | 20 | 20 | 20 |
| Reaction | Gel Time (G′ = G″) | min | 636 | 599 | 567 | 467 | 697 | 825 | 895 | >900 |
| properties | Gel time reduction | % | 9 | 14 | 19 | 33 | Control | 8 | Control | — |
| | V₁ | Pa · s | 44 | 33 | 33 | 64 | 39 | 47 | 41 | 46 |
| | V₂ | Pa · s | 55 | 50 | 54 | 88 | 46 | 64 | 41 | 47 |
| | V₂/V₁ | — | 1.2 | 1.5 | 1.6 | 1.4 | 1.2 | 1.4 | 1.0 | 1.0 |
| | T₁ | ° C. | 201.4 | 201.4 | 201.4 | 201.4 | 201.4 | 201.4 | 192.1 | 201.4 |
| | T₁ₚ | | 249.4 | 249.4 | 249.4 | 249.4 | 249.4 | 249.4 | 234.4 | 249.4 |
| | T₂ | | 200.9 | 200.9 | 200.9 | 200.9 | — | 200.9 | — | — |
| | T₂ₚ | | 250.3 | 250.3 | 250.3 | 250.3 | — | 250.3 | — | — |
| | T₁ − T₂ | | 0.5 | 0.5 | 0.5 | 0.5 | — | 0.5 | — | — |
| | T₁ₚ − T₂ₚ | | −0.9 | −0.9 | −0.9 | −0.9 | — | −0.9 | — | — |
| | T₅ | | 200.9 | 200.9 | 200.9 | 200.9 | — | 200.9 | — | — |
| | T₅ₚ | | 250.3 | 250.3 | 250.3 | 250.3 | — | 250.3 | — | — |
| | T₁ − T₅ | | 0.5 | 0.5 | 0.5 | 0.5 | — | 0.5 | — | — |
| | T₁ₚ − T₅ₚ | | −0.9 | −0.9 | −0.9 | −0.9 | — | −0.9 | — | — |

Gel time reduction: Gel time reduction relative to control resin
V₁: Viscosity after being held at 80° C. for 1 minute
V₂: Viscosity after being held at 80° C. for 4 hours
T₁: the extrapolated onset temperature (° C.) for reaction of a mixture of [A] and [B-1]
T₂: the extrapolated onset temperature (° C.) for reaction of a mixture of [A], [B-1], and [C]
T₅: the extrapolated onset temperature (° C.) for reaction of a mixture of [A], [B-1], and [C-1]
T₁ₚ: the peak temperature (° C.) for reaction of a mixture of [A] and [B-1]
T₂ₚ: the peak temperature (° C.) for reaction of a mixture of [A], [B-1], and [C]
T₅ₚ: the peak temperature (° C.) for reaction of a mixture of [A], [B-1], and [C-1]

TABLE B2

| | | | WE | WE | WE | WE | CE | CE | CE | CE |
|---|---|---|---|---|---|---|---|---|---|---|
| | | Units | B6 | B7 | B8 | B9 | B4 | B5 | B6 | B7 |
| Component | Araldite ® MY721 | Parts | 70 | 70 | 70 | 70 | 70 | 70 | 70 | 70 |
| [A] | Araldite ® MY0510 | | — | — | — | — | — | — | — | — |
| | Epon ™ 825 | | — | — | — | — | — | — | — | — |
| | EPICLON ® 830 | | — | — | — | — | — | — | — | — |
| | EPICLON ® HP-4770 | | — | — | — | — | — | — | — | — |
| | TOREP ® A-204E | | 30 | 30 | 30 | 30 | 30 | 30 | 30 | 30 |
| Component | SEIKACURE-S | Parts | — | — | — | — | — | — | — | — |
| [B-1] | Aradur ® 9719-1 | | 35 | 35 | 35 | 35 | 45 | 35 | 30 | 25 |
| Component | IDH-S | Parts | 8 | 8 | 8 | 8 | — | 8 | 12 | 16 |
| [B-2] | Technicure ® ADH | | — | — | — | — | — | — | — | — |
| Component | [C-1] TPP | Parts | 0.5 | 1.0 | 1.5 | 1.0 | — | — | — | — |
| [C] | [C-1] TPP-PB ® | | — | — | — | — | — | — | — | — |
| | [C-1] TPP-S ® | | — | — | — | — | — | — | — | — |
| | EPTS | Parts | — | — | — | — | — | — | — | — |
| | Piperidinium BF₃ | | — | — | — | — | — | — | — | — |
| | San-Aid SI-150 | | — | — | — | — | — | — | — | — |
| Thermoplastic | VW-10700RFP | Parts | 20 | 20 | 20 | — | 20 | 20 | 20 | 20 |
| Reaction | Gel Time (G′ = G″) | min | 509 | 408 | 331 | 400 | 592 | 536 | 541 | 546 |
| properties | Gel time reduction | % | 5 | 24 | 38 | 25 | — | Control | −1 | −2 |
| | V₁ | Pa · s | 23 | 27 | 31 | 0.5 | 25 | 22 | 15 | 15 |
| | V₂ | Pa · s | 30 | 37 | 61 | 0.7 | 29 | 26 | 18 | 17 |
| | V₂/V₁ | — | 1.3 | 1.4 | 2.0 | 1.4 | 1.2 | 1.1 | 1.2 | 1.2 |
| | T₁ | ° C. | 192.1 | 192.1 | 192.1 | 192.1 | 192.1 | 192.1 | 192.1 | 192.1 |
| | T₁ₚ | | 234.4 | 234.4 | 234.4 | 234.4 | 234.4 | 234.4 | 234.4 | 234.4 |
| | T₂ | | 193.0 | 193.0 | 193.0 | 193.0 | — | — | — | — |
| | T₂ₚ | | 234.9 | 234.9 | 234.9 | 234.9 | — | — | — | — |
| | T₁ − T₂ | | −0.9 | −0.9 | −0.9 | −0.9 | — | — | — | — |
| | T₁ₚ − T₂ₚ | | −0.4 | −0.4 | −0.4 | −0.4 | — | — | — | — |
| | T₅ | | 193.0 | 193.0 | 193.0 | 193.0 | — | — | — | — |
| | T₅ₚ | | 234.9 | 234.9 | 234.9 | 234.9 | — | — | — | — |
| | T₁ − T₅ | | −0.9 | −0.9 | −0.9 | −0.9 | — | — | — | — |
| | T₁ₚ − T₅ₚ | | −0.4 | −0.4 | −0.4 | −0.4 | — | — | — | — |

Gel time reduction: Gel time reduction relative to control resin
V₁: Viscosity after being held at 80° C. for 1 minute
V₂: Viscosity after being held at 80° C. for 4 hours
T₁: the extrapolated onset temperature (° C.) for reaction of a mixture of [A] and [B-1]
T₂: the extrapolated onset temperature (° C.) for reaction of a mixture of [A], [B-1], and [C]
T₅: the extrapolated onset temperature (° C.) for reaction of a mixture of [A], [B-1], and [C-1]
T₁ₚ: the peak temperature (° C.) for reaction of a mixture of [A] and [B-1]
T₂ₚ: the peak temperature (° C.) for reaction of a mixture of [A], [B-1], and [C]
T₅ₚ: the peak temperature (° C.) for reaction of a mixture of [A], [B-1], and [C-1]

TABLE B3

| | | | WE | WE | WE | CE | CE | CE | WE | CE |
|---|---|---|---|---|---|---|---|---|---|---|
| | | Units | B10 | B11 | B12 | B8 | B9 | B10 | B13 | B11 |
| Component | Araldite ® MY721 | Parts | 70 | 70 | 70 | 70 | 70 | 70 | 70 | 70 |
| [A] | Araldite ® MY0510 | | — | — | — | — | — | — | — | — |
| | Epon ™ 825 | | — | — | — | — | — | — | — | — |
| | EPICLON ® 830 | | — | — | — | — | — | — | — | — |
| | EPICLON ® HP-4770 | | — | — | — | — | — | — | — | — |
| | TOREP ® A-204E | | 30 | 30 | 30 | 30 | 30 | 30 | 30 | 30 |
| Component | SEIKACURE-S | Parts | — | — | — | — | — | — | — | — |
| [B-1] | Aradur ® 9719-1 | | 35 | 35 | 35 | 35 | 35 | 35 | 35 | 35 |
| Component | IDH-S | Parts | 8 | 8 | 8 | 8 | 8 | 8 | — | — |
| [B-2] | Technicure ® ADH | | — | — | — | — | — | — | 8 | 8 |
| Component | [C-1] TPP | Parts | — | — | — | — | — | — | 1.0 | — |
| [C] | [C-1] TPP-PB ® | | 0.6 | 1.0 | — | — | — | — | — | — |
| | [C-1] TPP-S ® | | — | — | 1.0 | — | — | — | — | — |
| | EPTS | Parts | — | — | — | 1.0 | — | — | — | — |
| | Piperidinium BF₃ | | — | — | — | — | 1.0 | — | — | — |
| | San-Aid SI-150 | | — | — | — | — | — | 1.0 | — | — |
| Thermoplastic | VW-10700RFP | Parts | 20 | 20 | 20 | 20 | 20 | 20 | 20 | 20 |
| Reaction | Gel Time (G′ = G″) | min | 424 | 400 | 432 | 339 | 387 | 432 | 612 | 632 |
| properties | Gel time reduction | % | 21 | 25 | 19 | 37 | 28 | 19 | 3 | Control |
| | V₁ | Pa · s | 30 | 37 | 49 | 23 | 25 | 25 | 36 | 32 |
| | V₂ | Pa · s | 40 | 51 | 77 | 91 | 74 | 51 | 46 | 36 |
| | V₂/V₁ | — | 1.3 | 1.4 | 1.6 | 4.0 | 2.9 | 2.1 | 1.3 | 1.1 |
| | T₁ | ° C. | 192.1 | 192.1 | 192.1 | 192.1 | 192.1 | 192.1 | 192.1 | 192.1 |
| | T₁ₚ | | 234.4 | 234.4 | 234.4 | 234.4 | 234.4 | 234.4 | 234.4 | 234.4 |
| | T₂ | | 191.1 | 191.1 | 188.4 | — | — | — | 193.0 | — |
| | T₂ₚ | | 234.7 | 234.7 | 234.4 | — | — | — | 234.9 | — |
| | T₁ − T₂ | | 1.0 | 1.0 | 3.8 | — | — | — | −0.9 | — |
| | T₁ₚ − T₂ₚ | | −0.2 | −0.2 | 0.1 | — | — | — | −0.4 | — |
| | T₅ | | 191.1 | 191.1 | 188.4 | 156.2 | 158.3 | 172.4 | 193.0 | — |
| | T₅ₚ | | 234.7 | 234.7 | 234.4 | 204.3 | 223.1 | 221.6 | 234.9 | — |
| | T₁ − T₅ | | 1.0 | 1.0 | 3.8 | 36.0 | 33.8 | 19.7 | −0.9 | — |
| | T₁ₚ − T₅ₚ | | −0.2 | −0.2 | 0.1 | 30.2 | 11.3 | 12.9 | −0.4 | — |

Gel time reduction: Gel time reduction relative to control resin
V₁: Viscosity after being held at 80° C. for 1 minute
V₂: Viscosity after being held at 80° C. for 4 hours
T₁: the extrapolated onset temperature (° C.) for reaction of a mixture of [A] and [B-1]
T₂: the extrapolated onset temperature (° C.) for reaction of a mixture of [A], [B-1], and [C]
T₅: the extrapolated onset temperature (° C.) for reaction of a mixture of [A], [B-1], and [C-1]
T₁ₚ: the peak temperature (° C.) for reaction of a mixture of [A] and [B-1]
T₂ₚ: the peak temperature (° C.) for reaction of a mixture of [A], [B-1], and [C]
T₅ₚ: the peak temperature (° C.) for reaction of a mixture of [A], [B-1], and [C-1]

TABLE B4

| | | | WE | CE | WE | CE | WE | CE | WE | CE |
|---|---|---|---|---|---|---|---|---|---|---|
| | | Units | B14 | B12 | B15 | B13 | B16 | B14 | B17 | B15 |
| Component | Araldite ® MY721 | Parts | 60 | 60 | 70 | 70 | 50 | 50 | — | — |
| [A] | Araldite ® MY0510 | | — | — | — | — | 50 | 50 | 50 | 50 |
| | Epon ™ 825 | | 40 | 40 | — | — | — | — | — | — |
| | EPICLON ® 830 | | — | — | — | — | — | — | 50 | 50 |
| | EPICLON ® HP-4770 | | — | — | 30 | 30 | — | — | — | — |
| | TOREP ® A-204E | | — | — | — | — | — | — | — | — |
| Component | SEIKACURE-S | Parts | — | — | — | — | — | — | — | — |
| [B-1] | Aradur ® 9719-1 | | 35 | 35 | 35 | 35 | 35 | 35 | 35 | 35 |
| Component | IDH-S | Parts | 8 | 8 | 8 | 8 | 8 | 8 | 8 | 8 |
| [B-2] | Technicure ® ADH | | — | — | — | — | — | — | — | — |
| Component | [C-1] TPP | Parts | 1.0 | — | 1.0 | — | 0.2 | — | 0.5 | — |
| [C] | [C-1] TPP-PB ® | | — | — | — | — | — | — | — | — |
| | [C-1] TPP-S ® | | — | — | — | — | — | — | — | — |
| | EPTS | Parts | — | — | — | — | — | — | — | — |
| | Piperidinium BF₃ | | — | — | — | — | — | — | — | — |
| | San-Aid SI-150 | | — | — | — | — | — | — | — | — |
| Thermoplastic | VW-10700RFP | Parts | 15 | 15 | 10 | 10 | 25 | 25 | 25 | 25 |
| Reaction | Gel Time (G′ = G″) | min | 313 | 342 | 299 | 337 | 337 | 363 | 263 | 342 |
| properties | Gel time reduction | % | 8 | Control | 11 | Control | 7 | Control | 23 | Control |
| | V₁ | Pa · s | 9 | 8 | 2 | 17 | 12 | 11 | 7 | 4 |
| | V₂ | Pa · s | 14 | 10 | 3 | 23 | 18 | 17 | 12 | 8 |
| | V₂/V₁ | — | 1.5 | 1.2 | 1.8 | 1.3 | 1.5 | 1.5 | 1.8 | 1.7 |
| | T₁ | ° C. | 176.4 | 176.4 | 180.4 | 180.4 | 175.2 | 175.2 | 169.6 | 169.6 |
| | T₁ₚ | | 222.4 | 222.4 | 223.7 | 223.7 | 223.7 | 223.7 | 215.7 | 215.7 |
| | T₂ | | 176.4 | — | 178.1 | — | 173.4 | — | 170.7 | — |
| | T₂ₚ | | 222.3 | — | 222.9 | — | 223.0 | — | 216.4 | — |
| | T₁ − T₂ | | 0.0 | — | 2.4 | — | 1.7 | — | −1.1 | — |
| | T₁ₚ − T₂ₚ | | 0.1 | — | 0.8 | — | 0.7 | — | −0.7 | — |
| | T₅ | | 176.4 | — | 178.1 | — | 173.4 | — | 170.7 | — |
| | T₅ₚ | | 222.3 | — | 222.9 | — | 223.0 | — | 216.4 | — |
| | T₁ − T₅ | | 0.0 | — | 2.4 | — | 1.7 | — | −1.1 | — |
| | T₁ₚ − T₅ₚ | | 0.1 | — | 0.8 | — | 0.7 | — | −0.7 | — |

Gel time reduction: Gel time reduction relative to control resin
V₁: Viscosity after being held at 80° C. for 1 minute
V₂: Viscosity after being held at 80° C. for 4 hours
T₁: the extrapolated onset temperature (° C.) for reaction of a mixture of [A] and [B-1]
T₂: the extrapolated onset temperature (° C.) for reaction of a mixture of [A], [B-1], and [C]
T₅: the extrapolated onset temperature (° C.) for reaction of a mixture of [A], [B-1], and [C-1]
T₁ₚ: the peak temperature (° C.) for reaction of a mixture of [A] and [B-1]
T₂ₚ: the peak temperature (° C.) for reaction of a mixture of [A], [B-1], and [C]
T₅ₚ: the peak temperature (° C.) for reaction of a mixture of [A], [B-1], and [C-1]

TABLE B5

| | | | WE | CE |
|---|---|---|---|---|
| | | Units | B18 | B16 |
| Component | Araldite ® MY721 | Parts | 70 | 70 |
| [A] | Araldite ® MY0510 | | — | — |
| | Epon ™ 825 | | — | — |
| | EPICLON ® 830 | | — | — |
| | EPICLON ® HP-4770 | | — | — |
| | TOREP ® A-204E | | 30 | 30 |
| Component | SEIKACURE-S | Parts | 35 | 35 |
| [B-1] | Aradur ® 9719-1 | | — | — |
| Component | IDH-S | Parts | — | — |
| [B-2] | NDH | | 11 | 11 |
| Component | [C-1] TPP | Parts | 0.6 | — |
| [C] | [C-1] TPP-PB ® | | — | — |
| | [C-1] TPP-S ® | | — | — |
| | EPTS | Parts | — | — |
| | Piperidinium BF₃ | | — | — |
| | San-Aid SI-150 | | — | — |
| Thermoplastic | VW-10700RFP | Parts | 20 | 20 |
| Reaction | Gel Time (G′ = G″) | min | 667 | 710 |
| properties | Gel time reduction | % | 6 | Control |
| | V₁ | Pa · s | 41 | 38 |
| | V₂ | Pa · s | 53 | 42 |
| | V₂/V₁ | — | 1.3 | 1.1 |
| | T₁ | ° C. | 201.4 | 201.4 |
| | T₁ₚ | | 249.4 | 249.4 |
| | T₂ | | 200.8 | — |
| | T₂ₚ | | 250.1 | — |
| | T₁ − T₂ | | 0.6 | — |
| | T₁ₚ − T₂ₚ | | −0.7 | — |
| | T₅ | | 200.8 | — |
| | T₅ₚ | | 250.1 | — |
| | T₁ − T₅ | | 0.6 | — |
| | T₁ₚ − T₅ₚ | | −0.7 | — |

Gel time reduction: Gel time reduction relative to control resin
V₁: Viscosity after being held at 80° C. for 1 minute
V₂: Viscosity after being held at 80° C. for 4 hours
T₁: the extrapolated onset temperature (° C.) for reaction of a mixture of [A] and [B-1]
T₂: the extrapolated onset temperature (° C.) for reaction of a mixture of [A], [B-1], and [C]
T₅: the extrapolated onset temperature (° C.) for reaction of a mixture of [A], [B-1], and [C-1]
T₁ₚ: the peak temperature (° C.) for reaction of a mixture of [A] and [B-1]
T₂ₚ: the peak temperature (° C.) for reaction of a mixture of [A], [B-1], and [C]
T₅ₚ: the peak temperature (° C.) for reaction of a mixture of [A], [B-1], and [C-1]

1. An epoxy resin composition comprising:
[A] at least one epoxy resin;
[B] at least two hardeners comprising:
[B-1] at least a first hardener;
[B-2] at least a second hardener different from the first hardener; and
[C] at least one accelerator,
wherein the epoxy resin composition satisfies (I):
5.0>|T₁−T₂| (I)
where
T₁ is an extrapolated onset temperature (° C.) for reaction of a mixture of [A] and [B-1];
T₂ is an extrapolated onset temperature (° C.) for reaction of a mixture of [A], [B-1], and [C]
wherein the extrapolated onset temperatures T₁ and T₂, are determined by differential scanning calorimetry with a heating rate of 10° C./min of the T₁ and T₂ mixtures having an equivalent ratio of all active hydrogens of [B-1] or [B-2] to all epoxy groups of [A] in the mixtures of 1.0 and a mass ratio of [C] to [A] of 1:100.

2. The epoxy resin composition according to claim 1, wherein the epoxy resin composition further satisfies (II):
5.0≤T₃−T₄ (II)
where
T₃ is an extrapolated onset temperature (° C.) for reaction of a mixture of [A] and [B-2]; and
T₄ is an extrapolated onset temperature (° C.) for reaction of a mixture of [A], [B-2], and [C],
wherein the extrapolated onset temperatures T₃ and T₄ are determined by differential scanning calorimetry with a heating rate of 10° C./min of the T₃ and T₄ mixtures having an equivalent ratio of all active hydrogens of [B-2] to all epoxy groups of [A] in the mixtures of 1.0 and a mass ratio of [C] to [A] of 1:100.

3. An epoxy resin composition comprising:
[A] at least one epoxy resin;
[B] at least two hardeners comprising:
[B-1] at least a first hardener;
[B-2] at least a second hardener different from the first hardener; and
[C] at least one accelerator,
wherein:
[B-1] comprises at least one amine compound,
[B-2] comprises at least one organic acid hydrazide compound,
[C] comprises [C-1] at least one organophosphorus compound, where the component [C-1] accelerates reaction of the component [A] and at least one hardener,
the component [A] is present in an amount of 100 parts by mass, the component [B-2] is present in an amount of 1 to 20 parts by mass, and the component [C-1] is present in an amount of 0.1 to 10 parts by mass, and
an equivalent ratio of all active hydrogens of the [B-1] and [B-2] components to all epoxy groups of the component [A] is 0.7 to 1.3.

4. The epoxy resin composition according to claim 1, wherein a ratio (V₂/V₁) of viscosity of the epoxy resin composition measured after being held at 80° C. for 4 hours (V₂) to that measured after being held at 80° C. for 1 minute (V₁) is 2.5 or less.

5. The epoxy resin composition according to claim 1, wherein a ratio (V₂/V₁) is 2.0 or less.

6. The epoxy resin composition according to claim 1, wherein the component [A] comprises at least one epoxy resin having three or more epoxy groups.

7. The epoxy resin composition according to claim 1, wherein the component [A] comprises at least one compound selected from the group consisting of a tetraglycidyl diaminodiphenyl methane, a meta- or para-aminophenol epoxy resin, and a bisnaphthalene epoxy resin.

8. The epoxy resin composition according to claim 1, wherein the component [B-1] comprises at least one amine compound.

9. The epoxy resin composition according to claim 1, wherein the component [B-1] comprises at least one aromatic amine compound.

10. The epoxy resin composition according to claim 9, wherein the component [B-1] comprises 3,3′-diaminodiphenylsulfone and/or 4,4′-diaminodiphenylsulfone.

11. The epoxy resin composition according to claim 1, wherein the component [B-2] comprises at least one organic acid hydrazide compound.

12. The epoxy resin composition according to claim 1, wherein the component [B-2] has at least one aromatic ring structure.

13. The epoxy resin composition according to claim 1, wherein the component [B-2] comprises at least one compound selected from the group consisting of 3-hydroxy-2-naphthoic acid hydrazide, 2,6-naphthalenedicarbodihydrazide, and isophthalic dihydrazide.

14. The epoxy resin composition according to claim 1, wherein an equivalent ratio of all active hydrogens of the component [B-1] to all active hydrogens of the component [B-2] is from 1 to 10.

15. The epoxy resin composition according to claim 1, wherein the component [C] comprises at least one compound selected from the group consisting of organophosphine compounds, phosphonium salts, and ammonium salts.

16. The epoxy resin composition according to claim 1, wherein the component [C] is at least one compound selected from the group consisting of triphenylphosphine, tetraphenylphosphonium bromide, triphenylphosphine triphenylborane, and tetrabutylammonium trifluoromethanesulfonate.

17. The epoxy resin composition according to claim 1, wherein the component [C] is present in an amount of 0.1 to 10 parts by mass relative to 100 parts by mass of the component [A].

18. The epoxy resin composition according to claim 1, wherein the component [A] is present in an amount of 100 parts by mass, the component [B-2] is present in an amount of 1 to 20 parts by mass, and the component [C] is present in an amount of 0.1 to 10 parts by mass, and wherein an equivalent ratio of all active hydrogens of the [B-1] and [B-2] components to all epoxy groups of the component [A] is 0.7 to 1.3.

19. The epoxy resin composition according to claim 3, wherein the component [C-1] has a melting point of 220° C. or less, when measured by differential scanning calorimetry with a heating rate of 10° C./min.

20. The epoxy resin composition according to claim 3, wherein the epoxy resin composition satisfies (V) and (VI):
5.0>|T₁−T₅| (V); and
2.0>|T₁ₚ−T₅ₚ| (VI);
where
T₁ is an extrapolated onset temperature (° C.) for reaction of a mixture of [A] and [B-1];
T₅ is an extrapolated onset temperature (° C.) for reaction of a mixture of [A], [B-1], and [C-1];
T₁ₚ is a peak temperature (° C.) for reaction of a mixture of [A] and [B-1]; and
T₅ₚ is a peak temperature (° C.) for reaction of a mixture of [A], [B-1], and [C-1];
wherein the extrapolated onset temperatures T₁ and T₅ and the peak temperatures T₁ₚ and T₅ₚ are determined by differential scanning calorimetry with a heating rate of 10° C./min using the aforementioned mixtures having an equivalent ratio of all active hydrogens of [B-1] or [B-2] to all epoxy groups of [A] in the mixtures of 1.0 and a mass ratio of [C-1] to [A] of 1:100.

21. The epoxy resin composition according to claim 3, wherein the component [C-1] comprises at least one organophosphine compound.

22. The epoxy resin composition according to claim 21, wherein the component [C-1] is at least one compound selected from the group consisting of triphenylphosphine, tri-o-tolylphosphine, tri-m-tolylphosphine, tri-p-tolylphosphine, tris(p-methoxyphenyl)phosphine, diphenylcyclohexylphosphine, triphenylphosphine oxide, and triphenylphosphine triphenylborane.

23. The epoxy resin composition according to claim 1, further comprising at least one thermoplastic resin.

24. The epoxy resin composition according to claim 23, wherein the thermoplastic resin is present in an amount of 1 to 30 parts by mass relative to 100 parts by mass of the component [A].

25. A prepreg comprising reinforcing fiber bundles impregnated with an epoxy resin composition according to claim 1.

26. A fiber-reinforced composite material obtained by curing a prepreg according to claim 25.

27. A fiber-reinforced composite material comprising a cured epoxy resin product obtained by curing a mixture comprising an epoxy resin composition according to claim 1 and a reinforcing fiber.
